(19) United States
(12) Patent Application Publication
(10) Pub. No.: US 2011/0208487 A1
(43) Pub. Date: Aug. 25, 2011

(54) COMPUTER BASED MODELING OF PROCESSED FIBROUS MATERIALS

(76) Inventors: Michael Timothy LOONEY, West Chester, OH (US); Jean-Philippe Marie Autran, Wyoming, OH (US); Olaf Erik Alexander Isele, West Chester, OH (US); Khalid Qureshi, Mason, OH (US); Amber Diane Fischer, Honolulu, HI (US)

(21) Appl. No.: 13/029,157

(22) Filed: Feb. 17, 2011

Related U.S. Application Data
(60) Provisional application No. 61/306,185, filed on Feb. 19, 2010.

(51) Int. Cl. G06F 17/50

(52) U.S. Cl. 703/1

(57) ABSTRACT

Computer based models of processed fibrous materials.

### CROSS-REFERENCE TO RELATED APPLICATION

This application claims priority to U.S. provisional application 61/306,185, filed Feb. 19, 2010, which is hereby incorporated by reference.

### FIELD

In general, embodiments of the present disclosure relate to fibrous materials. In particular, embodiments of the present disclosure relate to methods of modeling processed fibrous materials.

### BACKGROUND

A fibrous material is a structure of many fibers. The fibers can be processed to form the material. The fibrous material can also be further processed. The processing may weaken, strengthen, or change individual fibers at particular locations, depending on the process. Due to this complexity, it can be difficult to model the physical behavior of a processed fiber. In particular, it can be difficult to model the failure modes of a processed fiber. As a result, it can be difficult to create a realistic model of a processed fibrous material.

### SUMMARY

However, the present disclosure provides methods for modeling a processed fibrous material. The methods can model the physical behavior of a processed fiber, while accounting for the weakening, strengthening, and changes from a process. In particular, the methods can model the failure modes of a processed fiber. The methods can be used to create a realistic model of a processed fibrous material. As a result, processed fibrous materials can be evaluated and modified as computer based models before they are tested as real world things.

### BRIEF DESCRIPTION OF THE DRAWINGS

FIG. 1 illustrates an enlarged top view of an exemplary fibrous material.

FIG. 2 illustrates an enlarged top view of an exemplary underbonded fibrous material.

FIG. 3 illustrates an enlarged top view of an exemplary chemical bonded fibrous material.

FIG. 4 illustrates an enlarged side view of a computer based model of an unbonded fiber.

FIG. 5 illustrates an enlarged side view of a computer based model of a fiber that has been underbonded at a bond site.

FIG. 6 illustrates an enlarged side view of a computer based model of a fiber that has been chemically bonded at a bond site.

FIG. 7 is a stress-strain chart illustrating the strain energy of a fiber.

FIG. 8 illustrates an enlarged top view of an exemplary underbonded fibrous material with some broken fibers.

FIG. 9 illustrates an enlarged top view of an exemplary chemical bonded fibrous material with some broken fibers.

FIG. 10 illustrates an enlarged side view of a computer based model of an unbonded fiber that has been broken.

FIG. 11 illustrates an enlarged side view of a computer based model of an underbonded fiber that has been broken.

FIG. 12 illustrates an enlarged side view of a computer based model of a chemically bonded fiber that has been broken.

FIG. 13 illustrates an enlarged top view of an exemplary overbonded fibrous material.

FIG. 14 illustrates an enlarged top view of an exemplary overbonded fibrous material with some broken fibers.

FIG. 15 illustrates an enlarged side view of a computer based model of an unbonded fiber.

FIG. 16 illustrates an enlarged side view of a computer based model of a fiber that has been overbonded at a bond site.

FIG. 17 illustrates an enlarged side view of a computer based model of an overbonded fiber that has broken off from a bond site.

FIG. 18 illustrates an enlarged top view of an exemplary bonded fibrous material.

FIG. 19 illustrates an enlarged side view of a computer based model of a fiber that has been bonded at a bond site.

FIG. 20 illustrates an enlarged side view of a computer based model of a fiber that has been bonded at a bond site.

FIG. 21 illustrates an enlarged side view of a computer based model of a bonded fiber that has been partially broken.

FIG. 22 illustrates an enlarged side view of the computer based model of FIG. 21, which has been further broken.

FIG. 23 illustrates an enlarged side view of the computer based model of FIG. 22, which has been further broken.

FIG. 24 illustrates an enlarged side view of a computer based model of a bonded fiber that has been partially broken.

FIG. 25 illustrates an enlarged side view of the computer based model of FIG. 24, which has been further broken.

FIG. 26 illustrates an enlarged side view of the computer based model of FIG. 25, which has been further broken.

### DETAILED DESCRIPTION

The present disclosure provides methods for modeling a processed fibrous material. The methods can model the physical behavior of a processed fiber, while accounting for the weakening, strengthening, and changes from a process. In particular, the methods can model the failure modes of a processed fiber. The methods can be used to create a realistic model of a processed fibrous material. As a result, processed fibrous materials can be evaluated and modified as computer based models before they are tested as real world things.

The methods of the present disclosure can be used to create realistic models of various processed fibrous materials. Fibrous materials can be made from animal fibers, plant fibers, mineral fibers, synthetic fibers, etc. Fibrous materials can include short fiber, long fibers, continuous fibers, fibers of varying lengths or cross-sectional geometries, or combinations of any of these. In some cases, a fibrous material can include another material, can be joined to another material, or can be incorporated into another material. Fibrous materials can take many forms, such as fabrics, textiles, and composites. Examples of fabrics include fibrous textiles (woven or knitted fabrics), felts, nonwovens, papers, and others. Examples of fibrous composites include composite materials with polymeric fibers, carbon fibers, glass fibers, and metal fibers, to name a few. Throughout the present disclosure, nonwoven materials are used to describe and illustrate various embodiments. However, it is contemplated that embodiments of the present disclosure are not limited to nonwoven materials, but can be similarly applied to a wide variety of fibrous materials, such as those described above and others, as will be understood by one of skill in the art.

As an example, methods of the present disclosure can be used to create realistic models of bonded nonwoven materials. The term “nonwoven material” refers to a sheet-like structure (e.g. web) of fibers (sometimes referred to as filaments) that are interlaid in a non-uniform, irregular, or random manner. A nonwoven material can be a single layer structure or a multiple layer structure. A nonwoven material can also be joined to another material, such as a film, to form a laminate.

A nonwoven material can be made from various natural and/or synthetic materials. Exemplary natural materials include cellulosic fibers, such as cotton, jute, pulp, and the like; and also can include reprocessed cellulosic fibers like rayon or viscose. Natural fibers for a nonwoven material can be prepared using various processes such as carding, etc. Exemplary synthetic materials include but are not limited to synthetic thermoplastic polymers that are known to form fibers, which include, but are not limited to, polyolefins, e.g., polyethylene, polypropylene, polybutylene and the like; polyamides, e.g., nylon 6, nylon 6/6, nylon 10, nylon 12 and the like; polyesters, e.g., polyethylene terephthalate, polybutylene terephthalate, polylactic acid and the like; polycarbonate; polystyrene; thermoplastic elastomers; vinyl polymers; polyurethane; and blends and copolymers thereof.

Fibers of a relatively short length, e.g. 40 mm or less, are typically manufactured into a nonwoven using processes like drylaying, e.g. carding or airlaying, or wetlaying (including paper). Continuous fibers or filaments can be spun out of molten thermoplastics or chemical solutions and formed into a web using spunlaying/spunbonding, meltblowing, or electrospinning by example. Other means of forming a nonwoven is by film fibrillation. These processes can also be combined to form composite or layered fabric structures.

As used herein, the following meanings apply. The term “bonded fibrous material” refers to a fibrous material bonded with a bond pattern. The term “bond pattern” refers to a pattern of bond sites imparted to a fibrous material. The term “bond site” or “bond” refers to a distinct location, on a bonded fibrous material, at which the fibers or filaments are substantially more interconnected, when compared with the fibers or filaments of the area of the fibrous material adjacent to the bond site (i.e. the unbonded area).

In various embodiments, the methods of the present disclosure can be used to create realistic models of various processed fibrous materials, based on models of unprocessed fibrous materials, which are created as described in the US non-provisional patent application entitled “Computer Based Modeling of Fibrous Materials,” filed on TBD under attorney docket number TBD, which is incorporated herein by reference. For example, the methods of the present disclosure can be used to create realistic models of bonded fibrous materials by adding bond patterns to such models of fibrous materials. In particular, such models of fibrous materials can include fibers with realistic location, curliness, and orientation, while accounting for randomness and probabilities in a fiber laydown process, as disclosed in the patent application described above.

A bond pattern can be imparted to a fibrous material in various ways, such as by using heat, pressure, ultrasonic bonding, chemical bonding (e.g. by applying an additive, such as resin), other bonding means known in the art, or combinations of any of these. For example, a fibrous material can be bonded by passing the fibrous material through a nip formed by a heated calendar roll (with a plurality of raised lands) and another roll, such that the lands form bond sites on the fibrous material. A bond pattern may be uniform, regular, non-uniform, irregular, or random, or other patterns known in the art, or combinations of any of these.

The methods of the present disclosure can be implemented by using Computer Aided Engineering (CAE). CAE is a broad area of applied science in which technologists use software to develop computer based models that represent real world things. The models can be transformed to provide various information about the physical behavior of those real world things, under certain conditions and/or over particular periods of time. As an example, CAE can be used to design, create, simulate, and/or evaluate models of all kinds of fibrous materials, their features, structures, and compositions, as well as their performance characteristics, such as their tensile strengths and neckdown modulii.

There are several major categories of CAE, including Finite Element Analysis (FEA). In FEA, models representing mechanical articles, as well as their features, components, structures, and/or materials are transformed to predict stress, strain, displacement, deformation, and other mechanical behaviors. FEA represents a continuous solid material as a set of discrete elements. In FEA, the mechanical behavior of each element is calculated, using equations that describe mechanical behavior. The results of all of the elements are summed up, to represent the mechanical behavior of the material as a whole.

Commercially available software can be used to conduct CAE. Abaqus, from SIMULIA in Providence, R.I., and LSDyna from Livermore Software Technology Corp. in Livermore, Calif., are examples of commercially available FEA software. Alternatively, CAE software can be written as custom software. CAE software can be run on various computer hardware, such as a personal computer, a minicomputer, a cluster of computers, a mainframe, a supercomputer, or any other kind of machine on which program instructions can execute to perform CAE functions.

CAE software can represent a number of real world things, such as fibrous materials. CAE software can also represent articles that incorporate fibrous materials, such as absorbent articles. An absorbent article can receive, contain, and absorb bodily exudates (e.g. urine, menses, feces, etc.). Absorbent articles include products for sanitary protection, for hygienic use, and the like. Some absorbent articles are wearable. A wearable absorbent article is configured to be worn on or around a lower torso of a body of a wearer. Examples of wearable absorbent articles include diapers and incontinence undergarments.

Some absorbent articles are disposable. A disposable absorbent article is configured to be disposed of after a single use (e.g., not intended to be reused, restored, or laundered). Examples of disposable absorbent articles include disposable diapers, disposable incontinence undergarments, as well as feminine care pads and liners. Some absorbent articles are reusable. A reusable absorbent article is configured to be partly or wholly used more than once. In some embodiments, a reusable absorbent article may be configured such that part or all of the absorbent article is wear-resistant to laundering or fully launderable. An example of a reusable absorbent article is a diaper with a washable outer cover. In other embodiments, a reusable absorbent article may not be configured to be launderable.

CAE software can also represent other articles that incorporate fibrous materials, including wipes, diaper wipes, body wipes, toilet tissue, facial tissue, wound dressings, handkerchiefs, household wipes, window wipes, bathroom wipes, surface wipes, countertop wipes, floor wipes, and other articles, as will be understood by one of skill in the art.

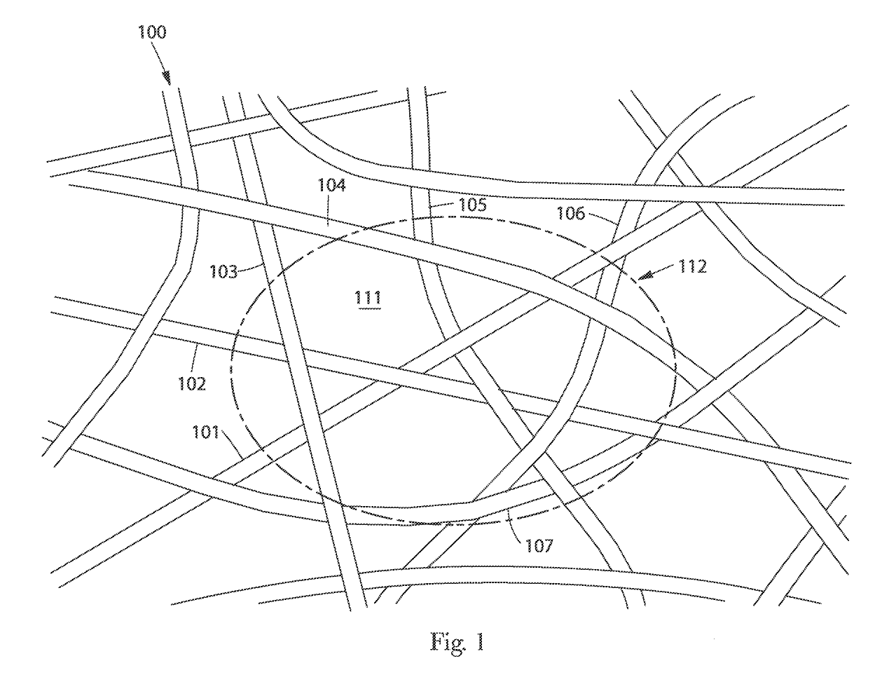

FIG. 1 illustrates an enlarged top view of an exemplary fibrous material 100. The fibrous material 100 has a plurality of fibers, including a first fiber 101, a second fiber 102, a third fiber 103, a fourth fiber 104, a fifth fiber 105, a sixth fiber 106, a seventh fiber 107, and additional fibers. The fibrous material 100 includes a bond site 111, with a bond site perimeter 112. The fibrous material 100 can be bonded at the bond site 111 by a bonding process. However, in FIG. 1, the fibrous material 100 is illustrated as not yet bonded. Portions of the fibers 101-107 are disposed within the bond site 111. Some of the fibers 101-107 disposed within the bond site 111 overlap each other. The fibers of the fibrous material 100 and the bond site 111 are disposed in substantially the same plane.

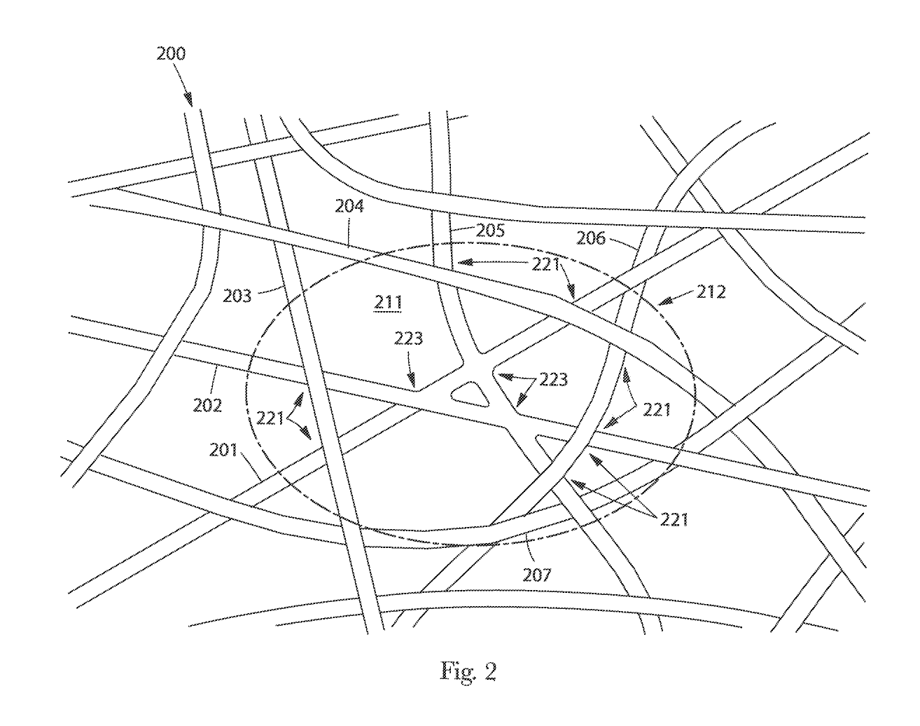

FIG. 2 illustrates an enlarged top view of an exemplary underbonded fibrous material 200. Each of the elements of the embodiment of FIG. 2 is configured in the same way as the like-numbered element of the embodiment of FIG. 1, except as described below.

Throughout the present disclosure, the term “like-numbered” is intended to indicate a correspondence between labels of elements wherein the last two numbers in the labels of the elements are the same. Element labels are considered to be like-numbered despite differing numeral prefixes corresponding to figure numbers, and despite differing suffixes corresponding to particular embodiments.

The fibrous material 200 is the fibrous material 100 after a bonding process has been applied. The bonding illustrated in FIG. 2 is underbonding. Throughout the present disclosure, the term underbonded is intended to describe a fibrous material that has been bonded by a bonding process, resulting in a relatively small degree of fiber connectedness at bond sites in or on the material. In other words, an underbonded material is a material that would have been stronger if the fibers were more interconnected at the bond sites.

As a result of the underbonding, portions of some of the fibers within the bond site 211 are fused 223 at locations where the fibers overlapped. However, other fibers within the bond site 211 remain overlapping 221 but not fused. As used herein, the term “fused” means melted together. FIG. 2 illustrates fusing by heat and/or pressure. In various embodiments, a bonding process can mechanically connect fibers in other ways besides fusing, such as static charging, the use of bonding agents, etc. Also as a result of the underbonding, the portions of the fibers 201-207 within the bond site 211 have been weakened, relative to their original unbonded state. Further, as a result of the underbonding, the portions of the fibers 201-207 disposed within the bond site 211 have been partially flattened, relative to their original cross-sectional shape.

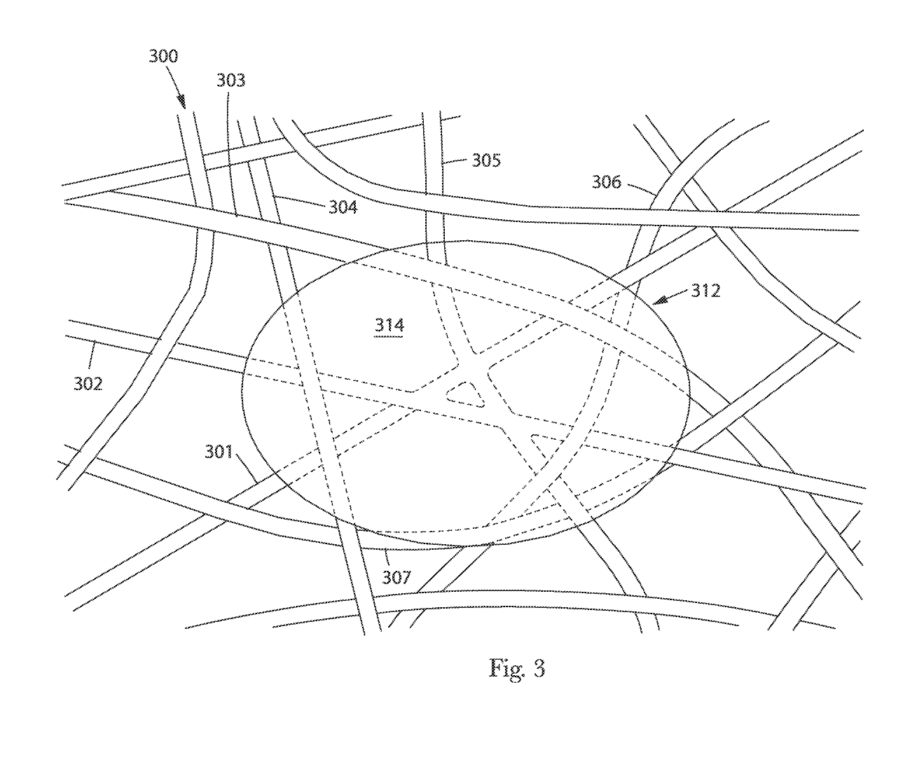

FIG. 3 illustrates an enlarged top view of an exemplary chemically bonded fibrous material 300. Each of the elements of the embodiment of FIG. 3 is configured in the same way as the like-numbered element of the embodiment of FIG. 1, except as described below. The fibrous material 300 is the fibrous material 100 after an additive 314 has been applied to the bond site 111 by a chemical bonding process. The additive 314 includes an additive perimeter 312. As a result of the chemical bonding, portions of the fibers within the additive perimeter 312 are covered by the additive 314. Also as a result of the chemical bonding, the portions of the fibers 301-307 disposed within the additive perimeter 312 have been strengthened, relative to their original unbonded state.

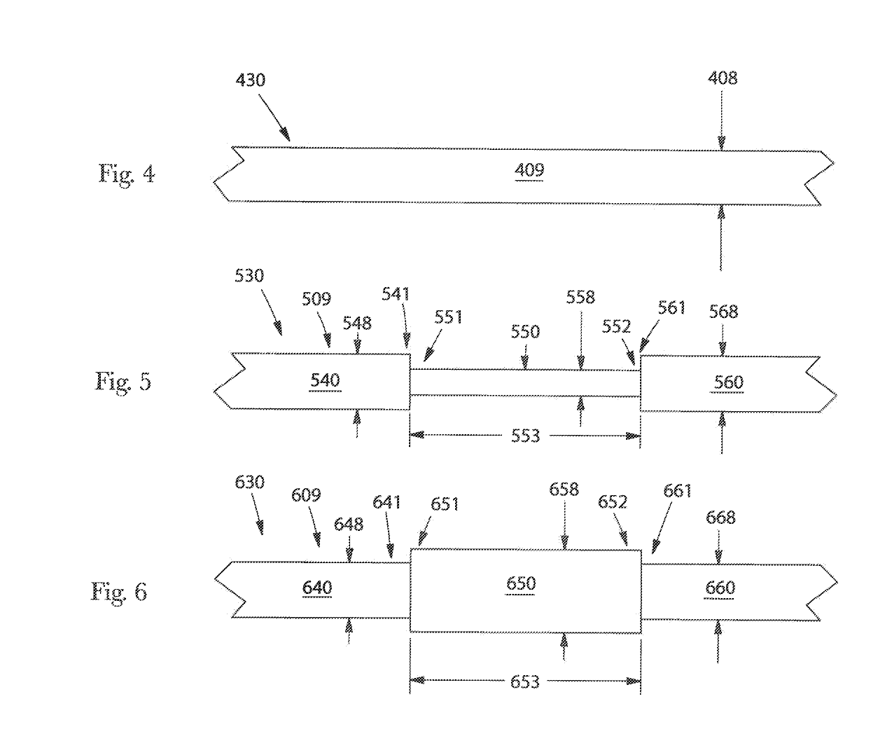

FIG. 4 illustrates an enlarged side view of a computer based model 430 of an unbonded fiber 409. The ends of the fiber 409 are broken to show that the fiber 409 has a length that extends beyond the illustrated portion. Models of fibers are illustrated in this way throughout the present disclosure. Since the fiber 409 is unbonded, the fiber 409 has a substantially uniform strength along its length. The substantially uniform strength is illustrated by a uniform diameter 408 along the length of the fiber 409.

While not shown in FIG. 4, the fiber 409 has a uniform circular cross-section. Each fiber disclosed herein has a uniform circular cross-section (unless otherwise stated); however, this is not required. In some embodiments, a fiber can have a cross-section that varies along the length of the fiber. In various embodiments, a fiber can have a cross-section with a different overall shape, such as oval, flat, tri-lobal, multi-lobal, etc.

The computer based models 430 of the unbonded fiber 409 can be created as described below, with general references to a computer based model of a fiber. A computer based model that represents a fiber can be created by providing dimensions and material properties to modeling software and by generating a mesh for the article using meshing software.

A computer based model of a fiber can be created with dimensions that are similar to or the same as dimensions that represent a real world fiber. These dimensions can be determined by measuring actual samples, by using known values, or by estimating values. Alternatively, a model of a fiber can be configured with dimensions that do not represent a real world fiber. For example, a model of a fiber can represent a new variation of a fiber or can represent an entirely new fiber. In these examples, dimensions for the model can be determined by varying actual or known values, by estimating values, or by generating new values. The model can be created by putting values for the dimensions of parts of the fiber into the modeling software.

The computer based model of the fiber can be created with material properties that are similar to or the same as material properties that represent a real world fiber. These material properties can be determined by measuring actual samples, by using known values, or by estimating values. Alternatively, a model of a fiber can be configured with material properties that do not represent a real world fiber. For example, a model of a fiber can represent a new variation of a real world fiber or can represent an entirely new fiber. In these examples, material properties for the model can be determined by varying actual or known values, by estimating values, or by generating new values.

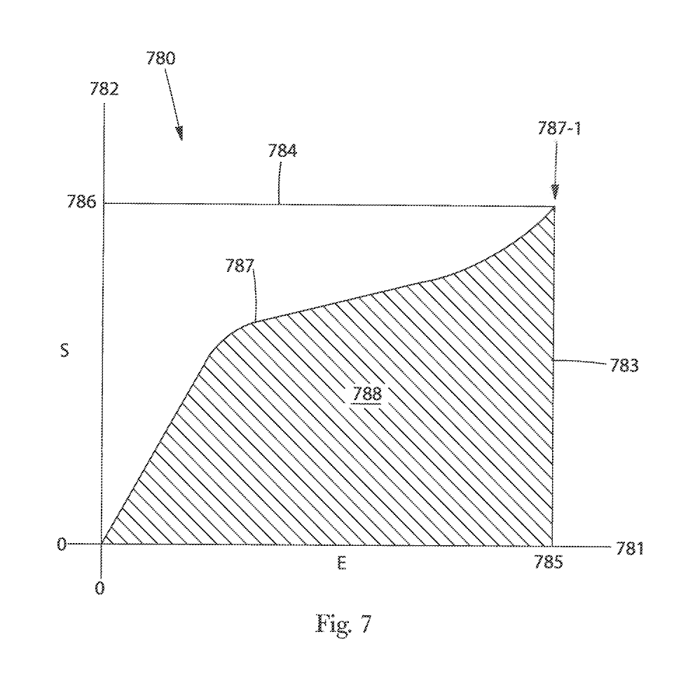

For example the mechanical strength behavior of a fiber can be measured and represented as the stress-strain behavior of a fiber pull test with a force gauge and conditions representing physical use conditions, obtaining a curve like in FIG. 7 of strain and stress data pairs. Further, the stress can be represented in force per cross-sectional area, where the cross-sectional area is derived from the fiber in a relaxed state (before strain), i.e. getting stress in units of Pascal. Further, the stress-strain curve can be represented by an equation involving several fitted parameters to match the stress-strain curve. For the model 430 of the fiber, the stress-strain relationship can be transformed into true stress strain data for finite element analysis. The mechanical strength behavior could also be represented as a simple force curve or another representation of strength versus displacement.

The computer based model of the fiber can be created with a mesh for the parts of the fiber. A mesh is a collection of small, connected geometric shapes that define the set of discrete elements in a CAE computer based model. The type of mesh and/or the size of elements can be controlled with user inputs into the meshing software, as will be understood by one of ordinary skill in the art. As examples, a segment of a fiber, an intermediate connection, and/or a bond site can be represented by using one or more beam elements, truss elements, other kinds of elements, or combinations of any of these. As further examples, a fiber bond connection can be represented by using one or more beam elements, truss elements, connector elements, other kinds of elements, or combinations of any of these. Alternatively, a fiber bond connection can be represented by using a contact condition, other kinds of conditions, or combinations of any of these. Each computer based model of a fiber, in the present disclosure, can be created in these ways.

The model 430 can serve as a basis for a computer based model of a fibrous material, such as the fibrous material 100 of the embodiment of FIG. 1. A computer based model can represent a fibrous material with a plurality of fibers wherein at least some, or substantially all, or even all of the fibers are represented in the same way as the fiber 409 of the model 430.

Program instructions can execute, causing a device to perform a method of representing the model 430, including any of its alternative embodiments. The execution can be performed with software, hardware, and combinations thereof, as described herein. These program instructions and any of these representations can be stored on a computer-readable medium.

FIG. 5 illustrates an enlarged side view of a computer based model 530 of a fiber 509 that has been underbonded at a bond site. The model 530 of the underbonded fiber 509 includes a first fiber segment 540, an intermediate connection 550, and a second fiber segment 560. The intermediate connection 550 represents the portion of the fiber 509 disposed within the bond site. The first fiber segment 540 and the second fiber segment 560 represent portions of the fiber 509 disposed outside of the bond site.

For conceptual simplicity, the bond site is not represented by a separate element in the embodiment of FIG. 5. However, in various embodiments, the model 530 can also include a representation of the bond site. In embodiments with a bond site, the model 530 can be configured with the underbonded fiber 509 connected to the bond site. Also, in embodiments with a bond site, the model 530 can be configured to include one or more additional fibers connected to the bond site. The additional fibers can be configured according to any of the embodiments of the present disclosure.

The first fiber segment 540 includes a first fiber segment end 541. The intermediate connection 550 includes a first end 551, a second end 552, and an overall length 553 between the first end 551 and the second end 552. The overall length 553 of the intermediate connection 550 can be based on a geometry of the bond site. For example, the overall length 553 of the intermediate connection can be selected such that the intermediate connection 550 extends across at least a portion of the bond site. As another example, the first end 551 and the second end 552 can be located at or near points along a perimeter of the bond site. The second fiber segment 560 includes a second fiber segment end 561.

The intermediate connection 550 directly connects the first fiber segment 540 to the second fiber segment 560. The first end 551 of the intermediate connection 550 is connected to the first fiber segment end 541. The second end 552 of the intermediate connection 550 is connected to the second fiber segment end 561. However, in various embodiments, an intermediate connection may connect a first fiber segment to a second fiber segment at one or more alternate locations along the fiber 509 or may indirectly connect a first fiber segment to a second fiber segment.

Since the fiber 509 is underbonded, the fiber 509 has varying strength along its length. The first fiber segment 540 has a first fiber breaking strength. Since the first fiber segment 540 was outside of the bond site, the first fiber segment 540 was not weakened by the underbonding. As a result, the first fiber breaking strength of the first fiber segment 540 is the same as the breaking strength of the fiber in its original unbonded state. The second fiber segment 560 has a second fiber breaking strength. Since the second fiber segment 560 was outside of the bond site, the second fiber segment 560 also was not weakened by the underbonding. As a result, the second fiber breaking strength is also the same as the breaking strength of the fiber in its original unbonded state.

The intermediate connection 550 has an intermediate connection breaking strength. Since the intermediate connection 550 was disposed within the bond site, the intermediate connection 550 was weakened by the underbonding. As a result, the intermediate connection breaking strength of the intermediate connection 550 is less than the breaking strength of the fiber in its original unbonded state. Thus, in the model 530, the intermediate connection breaking strength differs from the first fiber breaking strength and from the second fiber breaking strength. The intermediate connection breaking strength is less than the first fiber breaking strength and less than the second fiber breaking strength. In some embodiments, the intermediate connection can be configured to have an intermediate tensile breaking strength that is less than a first tensile breaking strength of the first fiber segment and less than a second tensile breaking strength of the second fiber segment.

In various embodiments, the intermediate connection breaking strength of the intermediate connection 550 can be based on the first fiber breaking strength of the first fiber segment 540 and/or on the second fiber breaking strength of the second fiber segment 560. For example, an intermediate connection breaking strength of an intermediate connection can be a fiber breaking strength of a fiber segment scaled down by a predetermined fiber strength factor. In some embodiments, the predetermined fiber strength factor can be 95%, 90%, 85%, 80%, 75%, or 70%, or any integer of percent between any of these values, or any range for percentage created by any of these values.

In various embodiments, the intermediate connection breaking strength of the intermediate connection 550 can be based on the strain energy at the first fiber breaking strength of the first fiber segment 540 and/or on the strain energy at the second fiber breaking strength of the second fiber segment 560, as described in connection with the embodiment of FIG. 7. For example, an intermediate connection can be configured with an intermediate connection breaking strength that corresponds with an intermediate connection strain energy that is equal to a strain energy at a breaking strength of a fiber segment, scaled down by a predetermined fiber strength factor. In some embodiments, the predetermined fiber strength factor can be 95%, 90%, 85%, 80%, 75%, or 70%, or any integer of percent between any of these values, or any range for percentage created by any of these values.

The varying strength in the underbonded fiber 509 is illustrated by varying diameters along its length. In models of fibers throughout the present disclosure, a relatively smaller fiber size illustrates lesser strength and a relatively larger fiber size illustrates greater strength. The portion of the fiber 509 disposed within the bond site has been weakened by the underbonding, relative to the portions of the fiber 509 outside of the bond site. The intermediate connection 550 corresponds with the portion of the fiber 609 disposed within the bond site. Thus, the intermediate connection 550 is weaker than first fiber segment 540 and the second fiber segment 560. To illustrate this relative weakness, the intermediate connection 550 has a diameter 558 that is smaller than a diameter 548 of the first fiber segment 540 and smaller than a diameter 568 of the second fiber segment 560. As a result of the varying strength in the underbonded fiber 509, the model 530 is configured to realistically represent the failure mode of fiber break in the fiber 509. This modeling approach can also be applied to represent a fiber with a portion weakened by some other process, as will be understood by one of skill in the art.

The model 530 can be transformed in various ways. Boundary conditions can position and/or constrain a model of a fiber, as described herein. Boundary conditions are defined variables that represent physical factors acting within a computer based model. Examples of boundary conditions include forces, pressures, velocities, and other physical factors. Each boundary condition can be assigned a particular magnitude, direction, and location within the model. These values can be determined by observing, measuring, analyzing, and/or estimating real world physical factors. In various embodiments, computer based models can also include one or more boundary conditions that differ from real world physical factors, in order to account for inherent limitations in the models and/or to more accurately represent the overall physical behaviors of real world things, as will be understood by one of ordinary skill in the art.

Boundary conditions can act on the model in various ways, to move, constrain, and/or deform one or more parts in the model. Each computer based model of a fiber, in the present disclosure, can be transformed by boundary conditions in these ways. A transformed fiber can also be represented with a computer based model of the transformed fiber. Further, each computer based model of a fibrous material, in the present disclosure, can be transformed by boundary conditions in these ways. A transformed fibrous material can also be represented with a computer based model of the transformed fibrous material.

The model 530 can serve as a basis for a computer based model of an underbonded fibrous material, such as the underbonded fibrous material 200 of the embodiment of FIG. 2. A computer based model can represent an underbonded fibrous material with a plurality of fibers wherein at least some, or substantially all, or even all of the fibers are represented in the same way as the fiber 509 of the model 530. The modeling approach of the embodiment of FIG. 5 can also be applied to represent a fibrous material with portions changed and/or weakened by some other process, as will be understood by one of skill in the art.

Program instructions can execute, causing a device to perform a method of representing the model 530, including any of its alternative embodiments. Program instructions can also execute, causing a device to perform a method of representing a computer based model of an underbonded fibrous material with fibers configured according to the model 530, including any of its alternative embodiments. The execution can be performed with software, hardware, and combinations thereof, as described herein. These program instructions and any of these representations can be stored on a computer-readable medium.

FIG. 6 illustrates an enlarged side view of a computer based model 630 of a fiber 609 that has been chemically bonded with an additive at a bond site. The model 630 of the chemically bonded fiber 609 includes a first fiber segment 640, an intermediate connection 650, and a second fiber segment 660. The intermediate connection 650 represents the portion of the fiber 609 disposed within the additive at the bond site. The first fiber segment 640 and the second fiber segment 660 represent portions of the fiber 609 disposed outside of the bond site. For conceptual simplicity, the bond site is represented by a separate element in the embodiment of FIG. 6. However, in various embodiments, the model 630 can also include a representation of the bond site, as described in connection with the model 530 of the embodiment of FIG. 5.

The first fiber segment 640 includes a first fiber segment end 641. The intermediate connection 650 includes a first end 651, a second end 652, and an overall length 653 between the first end 651 and the second end 652. The overall length 653 of the intermediate connection 650 can be based on a geometry of the bond site, as described in connection with the intermediate connection 550 of the embodiment of FIG. 5. The second fiber segment 660 includes a second fiber segment end 661. The intermediate connection 650 directly connects the first fiber segment 640 to the second fiber segment 660. The first end 651 of the intermediate connection 650 is connected to the first fiber segment end 641. The second end 652 of the intermediate connection 650 is connected to the second fiber segment end 661.

Since the fiber 609 is chemically bonded, the fiber 609 has varying strength along its length. The first fiber segment 640 has a first fiber breaking strength. Since the first fiber segment 640 was outside of the bond site, the first fiber segment 640 was not strengthened by the chemical bonding. As a result, the first fiber breaking strength of the first fiber segment 640 is the same as the breaking strength of the fiber in its original unbonded state. The second fiber segment 660 has a second fiber breaking strength. Since the second fiber segment 660 was outside of the bond site, the second fiber segment 660 also was not strengthened by the chemical bonding. As a result, the second fiber breaking strength is also the same as the breaking strength of the fiber in its original unbonded state.

The intermediate connection 650 has an intermediate connection breaking strength. Since the intermediate connection 650 was disposed within the bond site, the intermediate connection 650 was strengthened by the chemical bonding. As a result, the intermediate connection breaking strength of the intermediate connection 650 is greater than the breaking strength of the fiber in its original unbonded state. Thus, in the model 630, the intermediate connection breaking strength differs from the first fiber breaking strength and from the second fiber breaking strength. The intermediate connection breaking strength is greater than the first fiber breaking strength and greater than the second fiber breaking strength. In some embodiments, the intermediate connection can be configured to have an intermediate tensile breaking strength that is greater than a first tensile breaking strength of the first fiber segment and less than a second tensile breaking strength of the second fiber segment.

In various embodiments, the intermediate connection breaking strength of the intermediate connection 650 can be based on the first fiber breaking strength of the first fiber segment 640 and/or on the second fiber breaking strength of the second fiber segment 660. For example, an intermediate connection breaking strength of an intermediate connection can be a fiber breaking strength of a fiber segment scaled up by a predetermined fiber strength factor. In some embodiments, the predetermined fiber strength factor can be 105%, 110%, 115%, 120%, 125%, or 130%, or any integer of percent between any of these values, or any range for percentage created by any of these values.

In various embodiments, the intermediate connection breaking strength of the intermediate connection 650 can be based on the strain energy at the first fiber breaking strength of the first fiber segment 640 and/or on the strain energy at the second fiber breaking strength of the second fiber segment 560, as described in connection with the embodiment of FIG. 7. For example, an intermediate connection can be configured with an intermediate connection breaking strength that corresponds with an intermediate connection strain energy that is equal to a strain energy at a breaking strength of a fiber segment, scaled up by a predetermined fiber strength factor. In some embodiments, the predetermined fiber strength factor can be 105%, 110%, 115%, 120%, 125%, or 130%, or any integer of percent between any of these values, or any range for percentage created by any of these values.

The varying strength in the chemically bonded fiber 609 is illustrated by varying diameters along its length. The portion of the fiber 609 disposed within the additive at the bond site has been strengthened by the chemical bonding, relative to the portions of the fiber 609 outside of the bond site. The intermediate connection 650 corresponds with the portion of the fiber 609 disposed within the bond site. Thus, the intermediate connection 650 is stronger than first fiber segment 640 and the second fiber segment 660. To illustrate this relative strength, the intermediate connection 650 has a diameter 658 that is larger than a diameter 648 of the first fiber segment 640 and larger than a diameter 668 of the second fiber segment 660. As a result of the varying strength in the chemically bonded fiber 609, the model 630 is configured to realistically represent the failure mode of fiber break in the fiber 609.

The model 630 can serve as a basis for a computer based model of a chemically bonded fibrous material, such as the chemically bonded fibrous material 200 of the embodiment of FIG. 2. A computer based model can represent a chemically bonded fibrous material with a plurality of fibers wherein at least some, or substantially all, or even all of the fibers are represented in the same way as the fiber 609 of the model 630. The modeling approach of the embodiment of FIG. 6 can also be applied to represent a fibrous material with portions changed and/or strengthened by some other process, as will be understood by one of skill in the art.

Program instructions can execute, causing a device to perform a method of representing the model 630, including any of its alternative embodiments. Program instructions can also execute, causing a device to perform a method of representing a computer based model of a chemically bonded fibrous material with fibers configured according to the model 630, including any of its alternative embodiments. The execution can be performed with software, hardware, and combinations thereof, as described herein. These program instructions and any of these representations can be stored on a computer-readable medium.

The modeling approaches of the embodiments of FIGS. 4, 5, and 6 can be combined in various ways. As a first example, the modeling approach of the embodiment of FIG. 4 can be combined with the modeling approach of the embodiment of FIG. 5 to represent a fibrous material with portions in an original condition and portions in a weakened condition. As a second example, the modeling approach of the embodiment of FIG. 4 can be combined with the modeling approach of the embodiment of FIG. 6 to represent a fibrous material with portions in an original condition and portions in a strengthened condition. As a third example, the modeling approach of the embodiment of FIG. 5 can be combined with the modeling approach of the embodiment of FIG. 6 to represent a fibrous material with portions in a weakened condition and portions in a strengthened condition. As a fourth example, the modeling approach of the embodiment of FIG. 4 can be combined with the modeling approach of the embodiment of FIG. 5 and the modeling approach of the embodiment of FIG. 6 to represent a fibrous material with portions in an original condition, portions in a weakened condition, and portions in a strengthened condition. Program instructions can execute, causing a device to perform a method of representing a model based on any of these combinations. The execution can be performed with software, hardware, and combinations thereof, as described herein. These program instructions and any of these representations can be stored on a computer-readable medium.

FIG. 7 is a stress-strain chart 780 illustrating the strain energy of an unbonded fiber. The stress-strain chart 780 includes a horizontal strain axis 781 and a vertical stress axis 782. The stress-strain chart 780 includes a stress-strain curve 787 for the fiber as the fiber is loaded from a strain of zero to a point of failure 787-1. A vertical line 783 is drawn from the point of failure 787-1 to the strain axis 781, to determine a failure strain 785 corresponding with the point of failure 787-1. A horizontal line 784 is drawn from the point of failure 787-1 to the stress axis 782, to determine a failure stress 785 corresponding with the point of failure 787-1. The area 788 bounded by the stress-strain curve 787, the strain axis and the vertical line 783 is considered the strain energy for the fiber at the fiber's breaking strength. While the stress-strain chart 780 illustrates the strain energy of an unbonded fiber, the stress-strain chart may differ once that fiber is bonded. In various embodiments, the stress-strain chart of the embodiment of FIG. 7 may, alternatively, represent the strain energy of a bonded fiber.

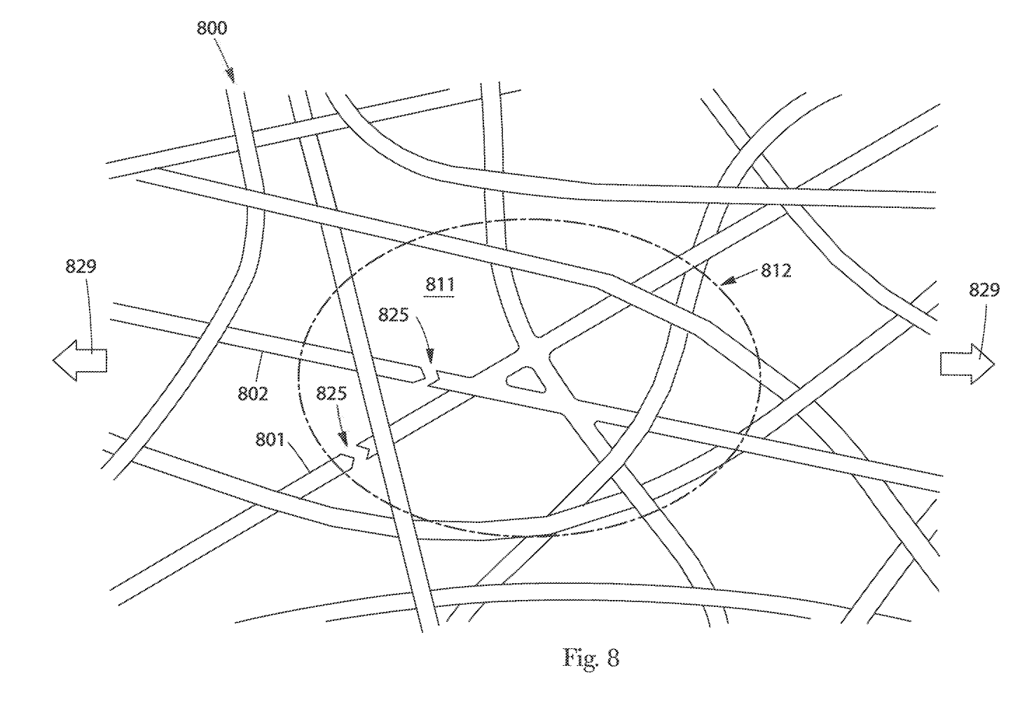

FIG. 8 illustrates an enlarged top view of an exemplary underbonded fibrous material 800 with some broken fibers. Each of the elements of the embodiment of FIG. 8 is configured in the same way as the like-numbered element of the embodiment of FIG. 2, except as described below. The fibrous material 800 is the underbonded fibrous material 200 after forces 829 have been applied. The forces 829 caused stress and strain in at least some of the fibers. The stress and strain caused some of those fibers to break. Since, the portions of the fibers within the bond site 811 had been weakened, those portions tended to break first. The fibers 801 and 802 are broken 825 at locations within the bond site 811. However, other portions of the fibers 801 and 802 remain intact. Also, other fibers in the fibrous material 800 also remain intact.

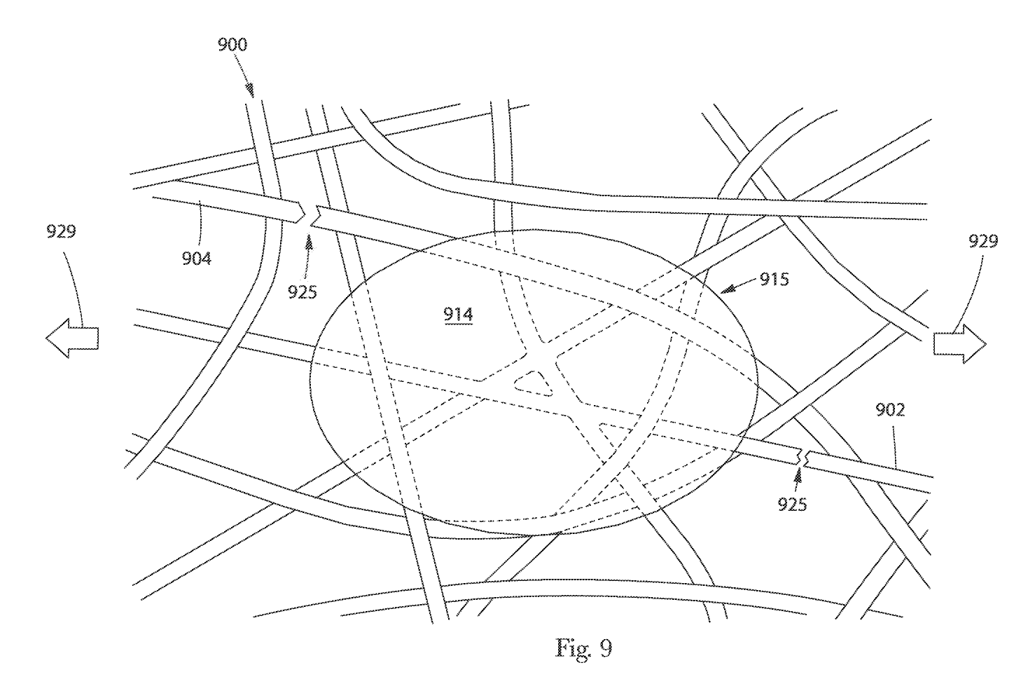

FIG. 9 illustrates an enlarged top view of an exemplary chemically bonded fibrous material 900 with some broken fibers. Each of the elements of the embodiment of FIG. 9 is configured in the same way as the like-numbered element of the embodiment of FIG. 3, except as described below. The fibrous material 900 is the chemically bonded fibrous material 300 after forces 929 have been applied. The forces 929 caused stress and strain in at least some of the fibers. The stress and strain caused some of those fibers to break. Since, the portions of the fibers within the additive 914 had been strengthened, portions of the fibers outside of the additive 914 tended to break first. The fibers 902 and 905 are broken 925 at locations outside of the additive 914. However, portions of the fibers within the additive 914 remain intact. Also, other fibers in the fibrous material 900 also remain intact.

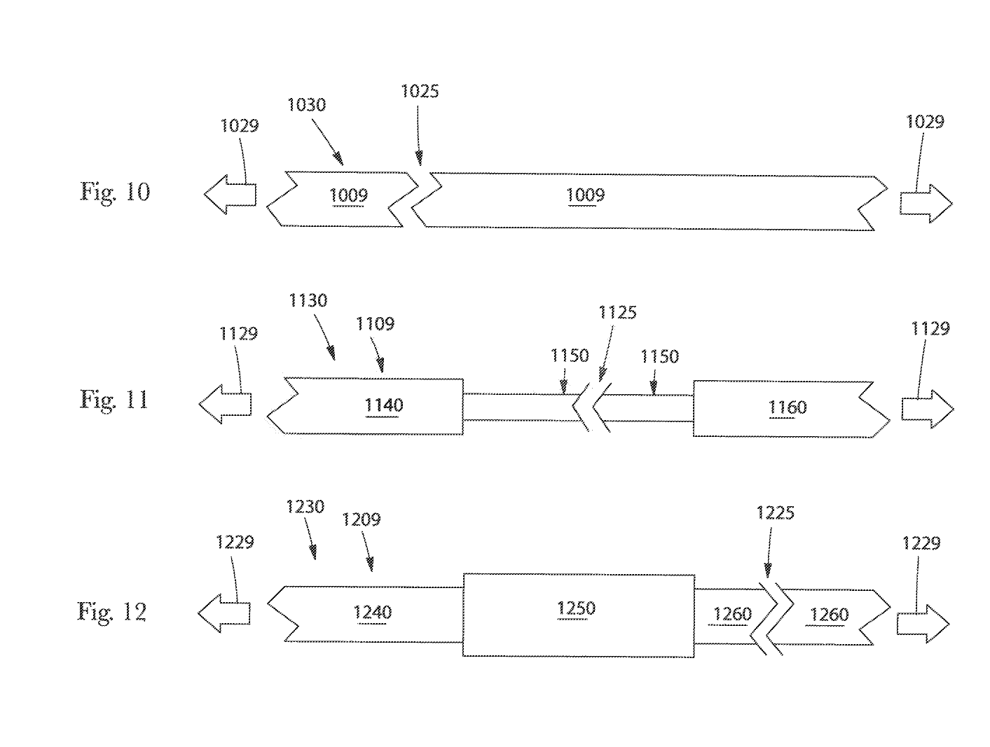

FIG. 10 illustrates an enlarged side view of a computer based model 1030 of a broken fiber 1009. Each of the elements of the embodiment of FIG. 10 is configured in the same way as the like-numbered element of the embodiment of FIG. 4, except as described below. The model 1030 is a representation of the model 430 after being transformed by forces 1029. The forces 1029 caused stress and strain in the elements of the model 1030, resulting in failure of an element. Since the fiber 1009 had substantially uniform strength, the fiber 1009 broke 1025 at a location that was essentially random. This is a realistic representation of the failure mode of fiber break in the fiber 1009.

The transformation of the model 430 into the transformed model 1030 can serve as a basis for transforming a computer based model of a fibrous material, such as the fibrous material 100 of the embodiment of FIG. 1. A computer based model can represent a transformed fibrous material with a plurality of fibers wherein at least some, or substantially all, or even all of the fibers are represented as being transformed in the same way as the fiber 1009 of the model 1030. In such a model of a fibrous material, the transformation may not result in any fiber break, may result in some fiber breaks, may result in many fiber breaks, may result in a partial structural failure of the web as a whole, or may result in a complete structural failure of the web as a whole.

Program instructions can execute, causing a device to perform a method of transforming the model 430 and representing the transformed model 1030, including any of their alternative embodiments. Program instructions can also execute, causing a device to perform a method of transforming a computer based model of a fibrous material with fibers configured according to the model 430, including any of its alternative embodiments, and representing the transformed model of the fibrous material, wherein the transformed fibers can be represented according to the model 1030. The execution can be performed with software, hardware, and combinations thereof, as described herein. These program instructions and any of these representations or transformations can be stored on a computer-readable medium.

FIG. 11 illustrates an enlarged side view of a computer based model 1130 of an underbonded fiber 1109 that has been broken. Each of the elements of the embodiment of FIG. 11 is configured in the same way as the like-numbered element of the embodiment of FIG. 5, except as described below. The model 1130 is a representation of the model 530 after being transformed by forces 1129. The forces 1129 caused stress and strain in the elements of the model 1130, resulting in failure of an element. Since the fiber 1109 had a weakened portion, represented by the intermediate connection 1150, the fiber 1109 broke 1125 at a location along the intermediate connection 1150. As a result of the break 1125, the first fiber segment 1140 is disconnected from the second fiber segment 1160. This is a realistic representation of the failure mode of fiber break in the underbonded fiber 1109.

The transformation of the model 530 into the transformed model 1130 can serve as a basis for transforming a computer based model of an underbonded fibrous material, such as the fibrous material 200 of the embodiment of FIG. 2. A computer based model can represent a transformed underbonded fibrous material with a plurality of fibers wherein at least some, or substantially all, or even all of the underbonded fibers are represented as being transformed in the same way as the fiber 1109 of the model 1130. In such a model of an underbonded fibrous material, the transformation may not result in any fiber break, may result in some fiber breaks, may result in many fiber breaks, may result in a partial structural failure of the web as a whole, or may result in a complete structural failure of the web as a whole.

Program instructions can execute, causing a device to perform a method of transforming the model 530 and representing the transformed model 1130, including any of their alternative embodiments. Program instructions can also execute, causing a device to perform a method of transforming a computer based model of a fibrous material with fibers configured according to the model 530, including any of its alternative embodiments, and representing the transformed model of the fibrous material, wherein the transformed fibers can be represented according to the model 1130. The execution can be performed with software, hardware, and combinations thereof, as described herein. These program instructions and any of these representations or transformations can be stored on a computer-readable medium.

FIG. 12 illustrates an enlarged side view of a computer based model 1230 of a chemically bonded fiber 1209 that has been broken. Each of the elements of the embodiment of FIG. 12 is configured in the same way as the like-numbered element of the embodiment of FIG. 6, except as described below. The model 1230 is a representation of the model 630 after being transformed by forces 1229. The forces 1229 caused stress and strain in the elements of the model 1230, resulting in failure of an element. Since the fiber 1209 had a strengthened portion, represented by the intermediate connection 1250, the fiber 1209 broke 1225 at a location outside of the intermediate connection 1250, in the second fiber segment 1260. As a result of the break 1225, the second fiber segment 1160 is broken into two portions that are disconnected from each other. This is a realistic representation of the failure mode of fiber break in the chemically bonded fiber 1209.

The transformation of the model 630 into the transformed model 1230 can serve as a basis for transforming a computer based model of a chemically bonded fibrous material, such as the fibrous material 300 of the embodiment of FIG. 3. A computer based model can represent a transformed chemically bonded fibrous material with a plurality of fibers wherein at least some, or substantially all, or even all of the chemically bonded fibers are represented as being transformed in the same way as the fiber 1209 of the model 1230. In such a model of a chemically bonded fibrous material, the transformation may not result in any fiber break, may result in some fiber breaks, may result in many fiber breaks, may result in a partial structural failure of the web as a whole, or may result in a complete structural failure of the web as a whole.

Program instructions can execute, causing a device to perform a method of transforming the model 630 and representing the transformed model 1230, including any of their alternative embodiments. Program instructions can also execute, causing a device to perform a method of transforming a computer based model of a fibrous material with fibers configured according to the model 630, including any of its alternative embodiments, and representing the transformed model of the fibrous material, wherein the transformed fibers can be represented according to the model 1230. The execution can be performed with software, hardware, and combinations thereof, as described herein. These program instructions and any of these representations or transformations can be stored on a computer-readable medium.

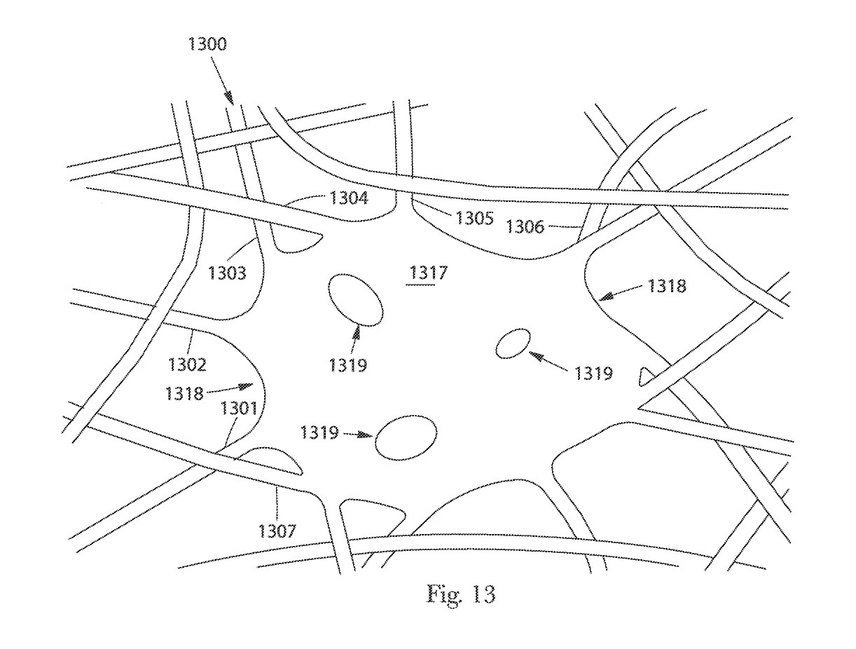

FIG. 13 illustrates an enlarged top view of an exemplary overbonded fibrous material 1300. Each of the elements of the embodiment of FIG. 13 is configured in the same way as the like-numbered element of the embodiment of FIG. 1, except as described below. The fibrous material 1300 is the fibrous material 100 after a bonding process has been applied. The bonding illustrated in FIG. 13 is overbonding. Throughout the present disclosure, the term overbonded is intended to describe a fibrous material that has been bonded by a bonding process, resulting in a relatively large degree of fiber connectedness at bond sites in or on the material. At an overbonded bond site, some fibers may be partially or wholly distinct or substantially all or all of the fibers may be fused into the bond site. In other words, an overbonded material is a material that would have been stronger if the fibers were less interconnected at the bond sites.

As a result of the overbonding, the portions of the fibers 1301-1307 within the bond site are no longer distinct; they are fused together, forming a fused area 1317. The fused area 1317 includes a fused area perimeter 1318 and some openings 1319. The fused area 1317 is stronger than the portions of the fibers 101-107 within the bond site 111 in their original unbonded state. However, as a result of the overbonding, portions of the fibers 1301-1307 adjacent to the fused area 1317 have been weakened, relative to their original unbonded state.

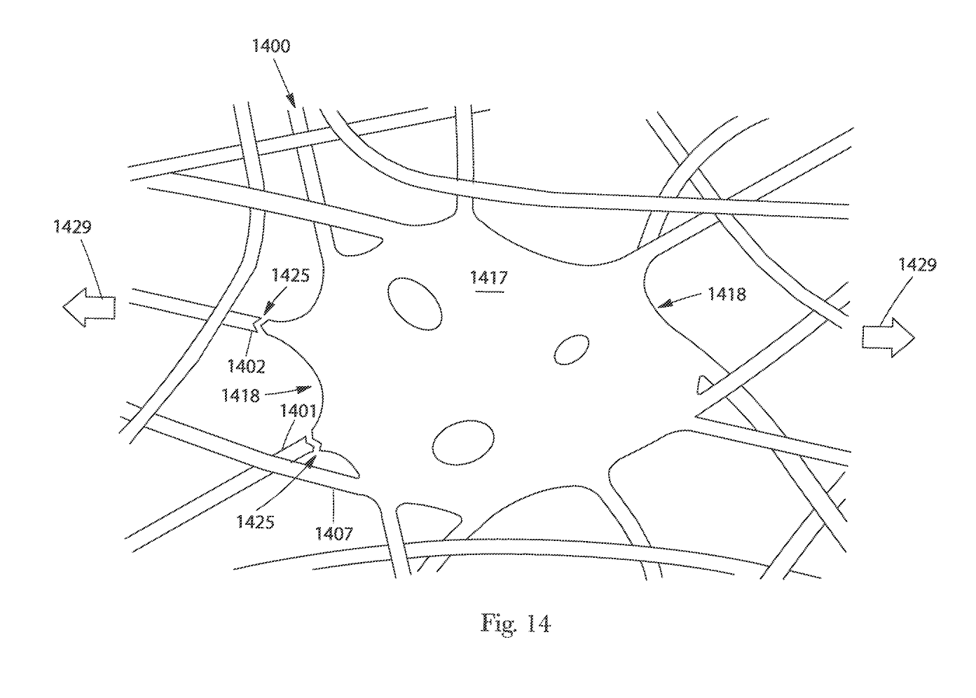

FIG. 14 illustrates an enlarged top view of an exemplary overbonded fibrous material 1400 with some broken fibers. Each of the elements of the embodiment of FIG. 14 is configured in the same way as the like-numbered element of the embodiment of FIG. 13, except as described below. The fibrous material 1400 is the fibrous material 1300 after forces 1429 have been applied. The forces 1429 caused stress and strain in at least some of the fibers. The stress and strain caused some of those fibers to break. Since, the portions of the fibers adjacent to the fused area 1417 had been weakened, those portions tended to break first. The fibers 1401 and 1402 are broken 1425 at locations adjacent to the fused area 1417. However, other portions of the fibers 1401 and 1402 remain intact. The fused area 1417 also remains intact.

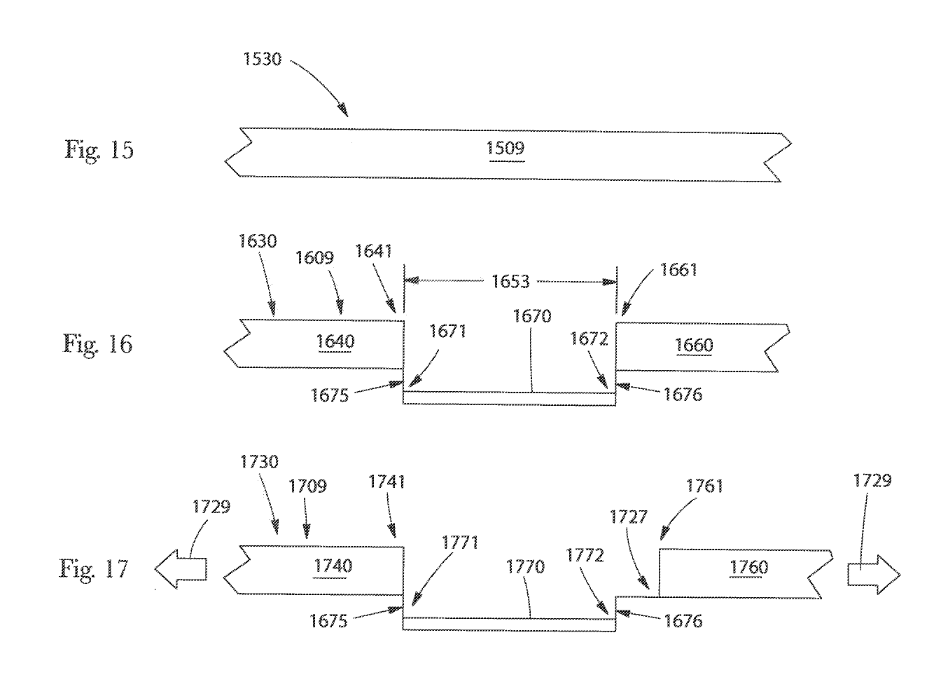

FIG. 15 illustrates an enlarged side view of a computer based model 1530 of an unbonded fiber 1509. The unbonded fiber 1509 is configured in the same way as the unbonded fiber 409. Since the fiber 1509 is unbonded, the fiber 1509 continues uninterrupted along its length.

FIG. 16 illustrates an enlarged side view of a computer based model 1630 of a fiber 1609 that has been overbonded at a bond site 1670. The model 1630 of the overbonded fiber 1609 includes a first fiber segment 1640, a first fiber bond connection 1675, the bond site 1670, a second fiber bond connection 1676, and a second fiber segment 1660. The bond site 1670 represents the bond site, which bonded the fiber 1609. The first fiber segment 1640 and the second fiber segment 1660 represent portions of the fiber 1609 disposed outside of the bond site, which bonded the fiber 1609. The first and second fiber bond connections 1675, 1676 represent transitional portions of the fiber 1609 adjacent to the bond site, which bonded the fiber 1609. In various embodiments, the computer based model 1630 may also include one or more elements that represent the portion of the fiber 1609 disposed within the bond site. For conceptual simplicity, that portion of the fiber is not represented by a separate element in the embodiment of FIG. 16. Also, in various embodiments, the model 1630 can be configured to include one or more additional fibers connected to the bond site 1670. The additional fibers can be configured according to any of the embodiments of the present disclosure.

The first fiber segment 1640 includes a first fiber segment end 1641. The bond site 1670 includes a first end 1671, a second end 1672, and an overall length 1653 between the first end 1671 and the second end 1672. The overall length 1653 of the bond site 1670 can be based on a geometry of the bond site, which bonded the fiber 1609. For example, the overall length 1653 of the bond site 1670 can be selected such that the bond site 1670 extends across at least a portion of the bond site, which bonded the fiber 1609. As another example, the first end 1671 and the second end 1672 can be located at or near points along a perimeter of the bond site, which bonded the fiber 1609. The second fiber segment 1660 includes a second fiber segment end 1661.

The bond site 1670 connects the first fiber segment 1640 to the second fiber segment 1660. The first end 1671 of the bond site 1670 is directly connected to the first fiber segment end 1641 by the first fiber bond connection 1675. The second end 1672 of the bond site 1670 is directly connected to the second fiber segment end 1661 by the second fiber bond connection 1676. However, in various embodiments, a bond site 1670 may connect a first fiber segment to a second fiber segment at one or more alternate locations along the fiber 1609 or may indirectly connect a first fiber segment to a second fiber segment.

Since the fiber 1609 is overbonded, the fiber 1609 does not continue uninterrupted along its length. The portion of the fiber 1609 within the bond site is no longer distinct; that portion is fused into a fused area. The bond site 1670 represents the fused area. The first and second fiber bond connections 1675, 1676 represent the portions of the fiber 1609 adjacent to the fused area. The first fiber segment 1640 and the second fiber segment 1660 represent portions of the fiber 1609 outside of the portions adjacent to the fused area.

The first fiber segment 1640 has a first fiber breaking strength. Since the first fiber segment 1640 was outside of the portions adjacent to the fused area, the first fiber segment 1640 was not weakened by the overbonding. As a result, the first fiber breaking strength of the first fiber segment 1640 is the same as the breaking strength of the fiber in its original unbonded state.

The second fiber segment 1660 has a second fiber breaking strength. Since the second fiber segment 1660 was outside of the portions adjacent to the fused area, the second fiber segment 1660 was not weakened by the overbonding. As a result, the second fiber breaking strength of the second fiber segment 1660 is the same as the breaking strength of the fiber in its original unbonded state.

The first fiber bond connection 1675 has a first fiber bond connection breaking strength. Since the first fiber bond connection 1675 was adjacent to the fused area, the first fiber bond connection 1675 was weakened by the overbonding. As a result, the first fiber bond connection breaking strength of the first fiber bond connection 1675 is less than the breaking strength of the fiber in its original unbonded state.

Thus, in the model 1630, the first fiber bond connection breaking strength differs from the first fiber breaking strength and from the second fiber breaking strength. The first fiber bond connection breaking strength is less than the first fiber breaking strength and less than the second fiber breaking strength. In some embodiments, the first fiber bond connection breaking strength can be configured to have a fiber bond connection tensile breaking strength that is less than a first tensile breaking strength of the first fiber segment and less than a second tensile breaking strength of the second fiber segment.

The second fiber bond connection 1676 has a second fiber bond connection breaking strength. Since the second fiber bond connection 1676 was adjacent to the fused area, the second fiber bond connection 1676 was weakened, with respect to the original strength of the fiber, by the overbonding. As a result, the second fiber bond connection breaking strength of the second fiber bond connection 1676 is less than the breaking strength of the fiber in its original unbonded state. In various embodiments, the second fiber bond connection breaking strength can be configured to be less than, equal to, or greater than the first fiber bond connection breaking strength.

Thus, in the model 1630, the second fiber bond connection breaking strength also differs from the first fiber breaking strength and from the second fiber breaking strength. The second fiber bond connection breaking strength is less than the first fiber breaking strength and less than the second fiber breaking strength. In some embodiments, the second fiber bond connection breaking strength can be configured to have a fiber bond connection tensile breaking strength that is less than a first tensile breaking strength of the first fiber segment and less than a second tensile breaking strength of the second fiber segment.

The bond site 1670 has a bond breaking strength. The bond breaking strength of the bond site 1670 is greater than the first fiber bond connection breaking strength and greater than the second fiber bond connection breaking strength. In various embodiments, the bond breaking strength may be less than, equal to, or greater than the breaking strength of the fiber 1609 in its original unbonded state. In various embodiments, the bond site 1670 can be configured to be flexible or rigid. As used herein, the term “flexible” refers to a material that can experience a substantial degree of bending deformation before fracture, and the term “rigid” refers to a material that cannot experience a substantial degree of bending deformation before fracture.

In various embodiments, the first fiber bond connection breaking strength of the first fiber bond connection 1675 can be based on the first fiber breaking strength of the first fiber segment 1640 and/or on the second fiber breaking strength of the second fiber segment 1660. Similarly, in various embodiments, the second fiber bond connection breaking strength of the second fiber bond connection 1676 can be based on the first fiber breaking strength of the first fiber segment 1640 and/or on the second fiber breaking strength of the second fiber segment 1660. For example, a fiber bond connection breaking strength of an fiber bond connection can be a fiber breaking strength of a fiber segment scaled down by a predetermined fiber strength factor. In some embodiments, the predetermined fiber strength factor can be 95%, 90%, 85%, 80%, 75%, or 70%, or any integer of percent between any of these values, or any range for percentage created by any of these values.

In various embodiments, the first fiber bond connection breaking strength of the first fiber bond connection 1675 can be based on the strain energy at the first fiber breaking strength of the first fiber segment 1640 and/or on the strain energy at the second fiber breaking strength of the second fiber segment 1660, as described in connection with the embodiment of FIG. 7. Similarly, in various embodiments, the second fiber bond connection breaking strength of the second fiber bond connection 1676 can be based on the strain energy at the first fiber breaking strength of the first fiber segment 1640 and/or on the strain energy at the second fiber breaking strength of the second fiber segment 1660, as described in connection with the embodiment of FIG. 7. For example, a fiber bond connection can be configured with a fiber bond connection breaking strength that corresponds with a fiber bond connection strain energy that is equal to a strain energy at a breaking strength of a fiber segment, scaled down by a predetermined fiber strength factor. In some embodiments, the predetermined fiber strength factor can be 95%, 90%, 85%, 80%, 75%, or 70%, or any integer of percent between any of these values, or any range for percentage created by any of these values.

As a result of the varying strengths in elements of the model 1630, the model 1630 is configured to realistically represent the failure mode of fiber break off for the fiber 1609. This modeling approach can also be applied to represent a fiber with portions changed and/or weakened by some other process, as will be understood by one of skill in the art.

The model 1630 can serve as a basis for a computer based model of an overbonded fibrous material, such as the overbonded fibrous material 1300 of the embodiment of FIG. 13. A computer based model can represent an overbonded fibrous material with a plurality of fibers wherein at least some, or substantially all, or even all of the fibers are represented in the same way as the fiber 1609 of the model 1630. The modeling approach of the embodiment of FIG. 16 can also be applied to represent a fibrous material with portions changed and/or strengthened by some other process, as will be understood by one of skill in the art.

Program instructions can execute, causing a device to perform a method of representing the model 1630, including any of its alternative embodiments. Program instructions can also execute, causing a device to perform a method of representing a computer based model of an overbonded fibrous material with fibers configured according to the model 1630, including any of its alternative embodiments. The execution can be performed with software, hardware, and combinations thereof, as described herein. These program instructions and any of these representations can be stored on a computer-readable medium.

FIG. 17 illustrates an enlarged side view of a computer based model 1730 of an overbonded fiber 1709 that has broken off from a bond site. Each of the elements of the embodiment of FIG. 17 is configured in the same way as the like-numbered element of the embodiment of FIG. 16, except as described below. The model 1730 is a representation of the model 1630 after being transformed by forces 1729. The forces 1729 caused stress and strain in the elements of the model 1730, resulting in failure of an element. Since the fiber 1709 had weakened portions, represented by the first and second fiber bond connections 1775, 1776, the second fiber bond connection 1776 failed, such that the second fiber segment 1760 broke off 1727 from the bond site 1770. As a result of the break off 1727, the first fiber segment 1740 is disconnected from the second fiber segment 1760. This is a realistic representation of the failure mode of fiber break off for the overbonded fiber 1709.

The transformation of the model 1630 into the transformed model 1730 can serve as a basis for transforming a computer based model of an overbonded fibrous material, such as the fibrous material 1300 of the embodiment of FIG. 13. A computer based model can represent a transformed overbonded fibrous material with a plurality of fibers wherein at least some, or substantially all, or even all of the overbonded fibers are represented as being transformed in the same way as the fiber 1709 of the model 1730. In such a model of an overbonded fibrous material, the transformation may not result in any fiber break, may result in some fiber breaks, may result in many fiber breaks, may result in a partial structural failure of the web as a whole, or may result in a complete structural failure of the web as a whole.

Program instructions can execute, causing a device to perform a method of transforming the model 1630 and representing the transformed model 1730, including any of their alternative embodiments. Program instructions can also execute, causing a device to perform a method of transforming a computer based model of a fibrous material with fibers configured according to the model 1630, including any of its alternative embodiments, and representing the transformed model of the fibrous material, wherein the transformed fibers can be represented according to the model 1730. The execution can be performed with software, hardware, and combinations thereof, as described herein. These program instructions and any of these representations or transformations can be stored on a computer-readable medium.

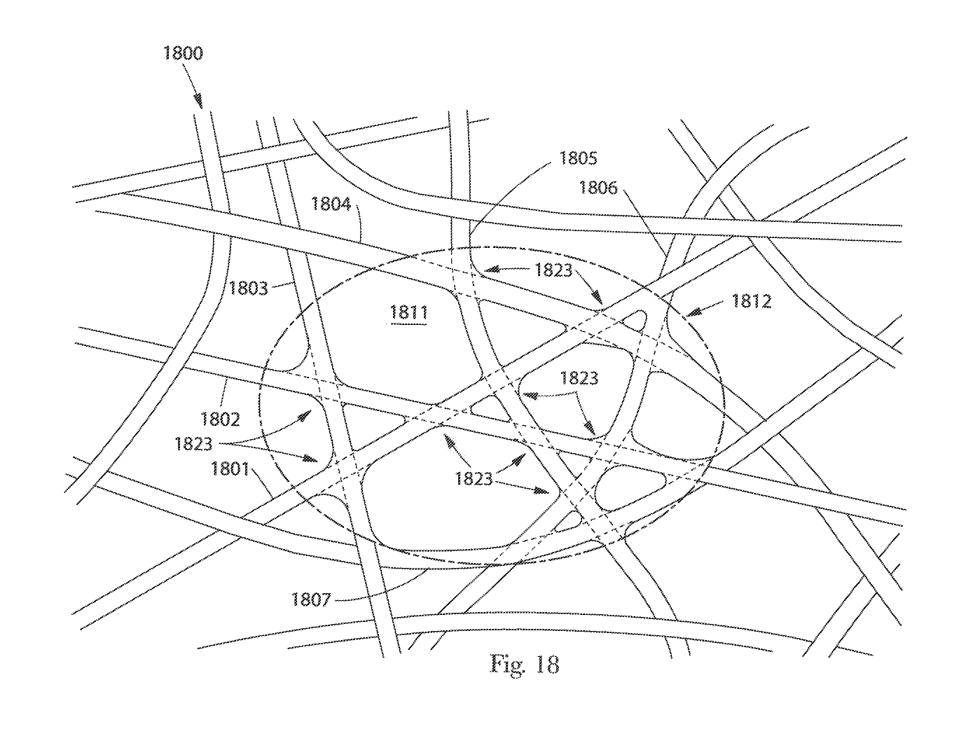

FIG. 18 illustrates an enlarged top view of an exemplary bonded fibrous material 1800. The fibrous material 1800 is the fibrous material 100 after a bonding process has been applied. Each of the elements of the embodiment of FIG. 18 is configured in the same way as the like-numbered element of the embodiment of FIG. 1, except as described below. The bonding illustrated in FIG. 18 is neither underbonding nor overbonding As a result of the bonding, the portions of the fibers 1801-1807 within the bond site are no longer entirely distinct; they are at least partially fused 1823 together at locations where the fibers overlapped. Also as a result of the bonding, the portions of the fibers 1801-1807 within the bond site have been weakened, relative to their original unbonded state. Further, as a result of the bonding, portions of the fibers 1801-1807 adjacent to the bond site have been weakened, relative to their original unbonded state.

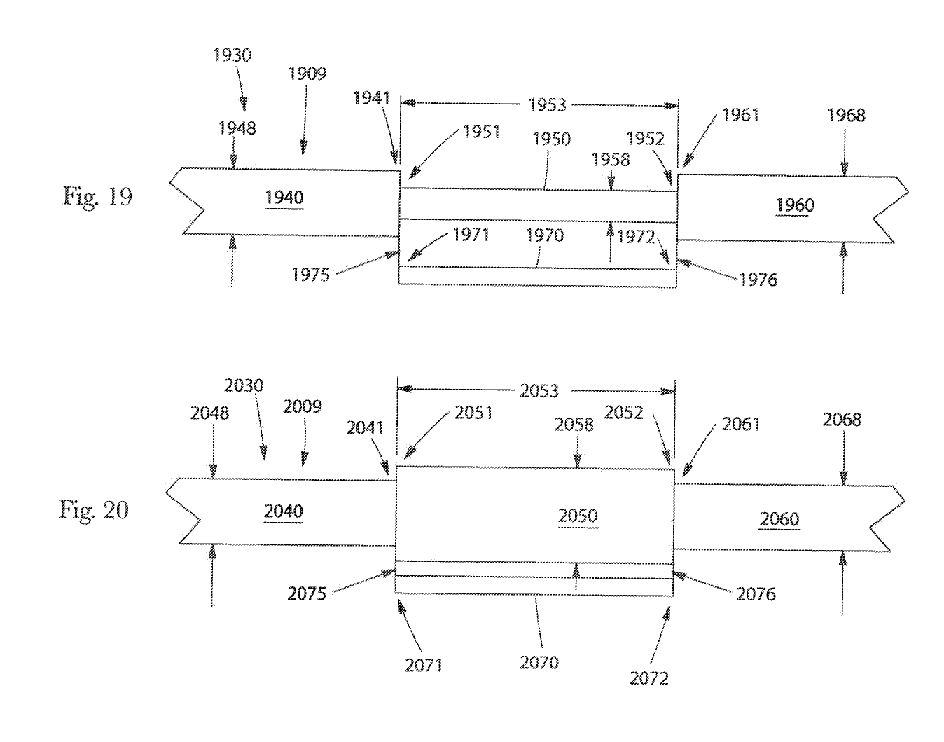

FIG. 19 illustrates an enlarged side view of a computer based model 1930 of a fiber 1909 that has been bonded at a bond site. The model 1930 of the bonded fiber 1909 includes a first fiber segment 1940, an intermediate connection 1950, a first fiber bond connection 1975, a bond site 1970, a second fiber bond connection 1976, and a second fiber segment 1960. The bond site 1970 represents the bond site, which bonded the fiber 1909. The intermediate connection 1950 represents the portion of the fiber 1909 disposed within the bond site. In the embodiment of FIG. 19, the intermediate connection 1950 was weakened by the bonding. The first fiber segment 1940 and the second fiber segment 1960 represent portions of the fiber 1909 disposed outside of the bond site, which bonded the fiber 1609. The first and second fiber bond connections 1975, 1976 represent portions of the fiber 1909 adjacent to the bond site, which bonded the fiber 1609. Also, in various embodiments, the model 1930 can be configured to include one or more additional fibers connected to the bond site 1970. The additional fibers can be configured according to any of the embodiments of the present disclosure.

The model 1930 is a combination of the model 530 of the embodiment of FIG. 5 and the model 1630 of the embodiment of FIG. 16. The intermediate connection 1950 is configured in the same way as the intermediate connection 550 of FIG. 5, except as described below. The first fiber segment 1940, the first fiber bond connection 1975, the bond site 1970, the second fiber bond connection 1976, and the second fiber segment 1960 are configured in the same way as the like-numbered elements of the embodiment of FIG. 16, except as described below. As a result, the model 1930 is configured to realistically represent the failure modes of fiber break and fiber break off for the fiber 1909.

In various embodiments of the model 1930, the intermediate connection 1950 can be configured with an intermediate connection breaking strength that is based, at least in part, on the first fiber bond connection breaking strength of the first fiber bond connection 1975 and/or the second fiber bond connection breaking strength of the second fiber bond connection 1976. In some embodiments of the model 1930, the first fiber bond connection 1975 can be configured with a first fiber bond connection breaking strength that is based, at least in part, on the intermediate connection breaking strength of the intermediate connection 1950; and/or the second fiber bond connection 1976 can be configured with a second fiber bond connection breaking strength that is based, at least in part, on the intermediate connection breaking strength of the intermediate connection 1950.

As an example, the intermediate connection breaking strength can be configured to vary inversely with either or both fiber bond connection breaking strengths. This example configuration can be used to determine an intermediate connection breaking strength and fiber bond connection breaking strength(s) for a model of a material, wherein a simulated ultimate strength of the modeled material matches the actual ultimate strength of a real world material.

In other embodiments of the model 1930, the intermediate connection 1950 can be configured with an intermediate connection breaking strength that is independent of the first fiber bond connection breaking strength of the first fiber bond connection 1975 and/or the second fiber bond connection breaking strength of the second fiber bond connection 1976.

The model 1930 can serve as a basis for a computer based model of a bonded fibrous material, such as the bonded fibrous material 1800 of the embodiment of FIG. 18. A computer based model can represent a bonded fibrous material with a plurality of fibers wherein at least some, or substantially all, or even all of the fibers are represented in the same way as the fiber 1909 of the model 1930. The modeling approach of the embodiment of FIG. 19 can also be applied to represent a fibrous material with portions changed by some other process, as will be understood by one of skill in the art.

Program instructions can execute, causing a device to perform a method of representing the model 1930, including any of its alternative embodiments. Program instructions can also execute, causing a device to perform a method of representing a computer based model of a bonded fibrous material with fibers configured according to the model 1930, including any of its alternative embodiments. The execution can be performed with software, hardware, and combinations thereof, as described herein. These program instructions and any of these representations can be stored on a computer-readable medium.

FIG. 20 illustrates an enlarged side view of a computer based model 2030 of a fiber 2009 that has been chemically bonded at a bond site. The model 2030 of the underbonded fiber 2009 includes a first fiber segment 2040, an intermediate connection 2050, a first fiber bond connection 2075, a bond site 2070, a second fiber bond connection 2076, and a second fiber segment 2060. The bond site 2070 represents the additive at the bond site, which bonded the fiber 2009. The intermediate connection 2050 represents the portion of the fiber 2009 disposed within the additive. In the embodiment of FIG. 20, the intermediate connection 2050 was strengthened by the bonding. The first fiber segment 2040 and the second fiber segment 2060 represent portions of the fiber 2009 disposed outside of the additive. The first and second fiber bond connections 2075, 2076 represent portions of the fiber 2009 adjacent to the additive. Also, in various embodiments, the model 2030 can be configured to include one or more additional fibers connected to the bond site 2070. The additional fibers can be configured according to any of the embodiments of the present disclosure.

The model 2030 is a combination of the model 630 of the embodiment of FIG. 6 and the model 1630 of the embodiment of FIG. 16. The intermediate connection 2050 is configured in the same way as the intermediate connection 650 of FIG. 6, except as described below. The first fiber segment 2040, the first fiber bond connection 2075, the bond site 2070, the second fiber bond connection 2076, and the second fiber segment 2060 are configured in the same way as the like-numbered elements of the embodiment of FIG. 16, except as described below. As a result, the model 2030 is configured to realistically represent the failure modes of fiber break and fiber break off for the fiber 2009.

In various embodiments of the model 2030, the intermediate connection 2050 can be configured with an intermediate connection breaking strength that is based, at least in part, on the first fiber bond connection breaking strength of the first fiber bond connection 2075 and/or the second fiber bond connection breaking strength of the second fiber bond connection 2076. In some embodiments of the model 2030, the first fiber bond connection 2075 can be configured with a first fiber bond connection breaking strength that is based, at least in part, on the intermediate connection breaking strength of the intermediate connection 2050; and/or the second fiber bond connection 2076 can be configured with a second fiber bond connection breaking strength that is based, at least in part, on the intermediate connection breaking strength of the intermediate connection 2050.

As an example, the intermediate connection breaking strength can be configured to vary inversely with either or both fiber bond connection breaking strengths. This example configuration can be used to determine an intermediate connection breaking strength and fiber bond connection breaking strength(s) for a model of a material, wherein a simulated ultimate strength of the modeled material matches the actual ultimate strength of a real world material.

In other embodiments of the model 2030, the intermediate connection 2050 can be configured with an intermediate connection breaking strength that is independent of the first fiber bond connection breaking strength of the first fiber bond connection 2075 and/or the second fiber bond connection breaking strength of the second fiber bond connection 2076.

The model 2030 can serve as a basis for a computer based model of a chemically bonded fibrous material, such as the chemically bonded fibrous material 300 of the embodiment of FIG. 3. A computer based model can represent a chemically bonded fibrous material with a plurality of fibers wherein at least some, or substantially all, or even all of the fibers are represented in the same way as the fiber 2009 of the model 2030. The modeling approach of the embodiment of FIG. 20 can also be applied to represent a fibrous material with portions changed by some other process, as will be understood by one of skill in the art.

Program instructions can execute, causing a device to perform a method of representing the model 2030, including any of its alternative embodiments. Program instructions can also execute, causing a device to perform a method of representing a computer based model of a bonded fibrous material with fibers configured according to the model 2030, including any of its alternative embodiments. The execution can be performed with software, hardware, and combinations thereof, as described herein. These program instructions and any of these representations can be stored on a computer-readable medium.

The modeling approaches of the embodiments of FIGS. 4, 19, and 20 can be combined in various ways. As a first example, the modeling approach of the embodiment of FIG. 4 can be combined with the modeling approach of the embodiment of FIG. 19 to represent a fibrous material with portions in an original condition and portions in a weakened condition. As a second example, the modeling approach of the embodiment of FIG. 4 can be combined with the modeling approach of the embodiment of FIG. 20 to represent a fibrous material with portions in an original condition and portions in a strengthened condition. As a third example, the modeling approach of the embodiment of FIG. 19 can be combined with the modeling approach of the embodiment of FIG. 20 to represent a fibrous material with portions in a weakened condition and portions in a strengthened condition. As a fourth example, the modeling approach of the embodiment of FIG. 4 can be combined with the modeling approach of the embodiment of FIG. 19 and the modeling approach of the embodiment of FIG. 20 to represent a fibrous material with portions in an original condition, portions in a weakened condition, and portions in a strengthened condition. Program instructions can execute, causing a device to perform a method of representing a model based on any of these combinations. The execution can be performed with software, hardware, and combinations thereof, as described herein. These program instructions and any of these representations can be stored on a computer-readable medium.

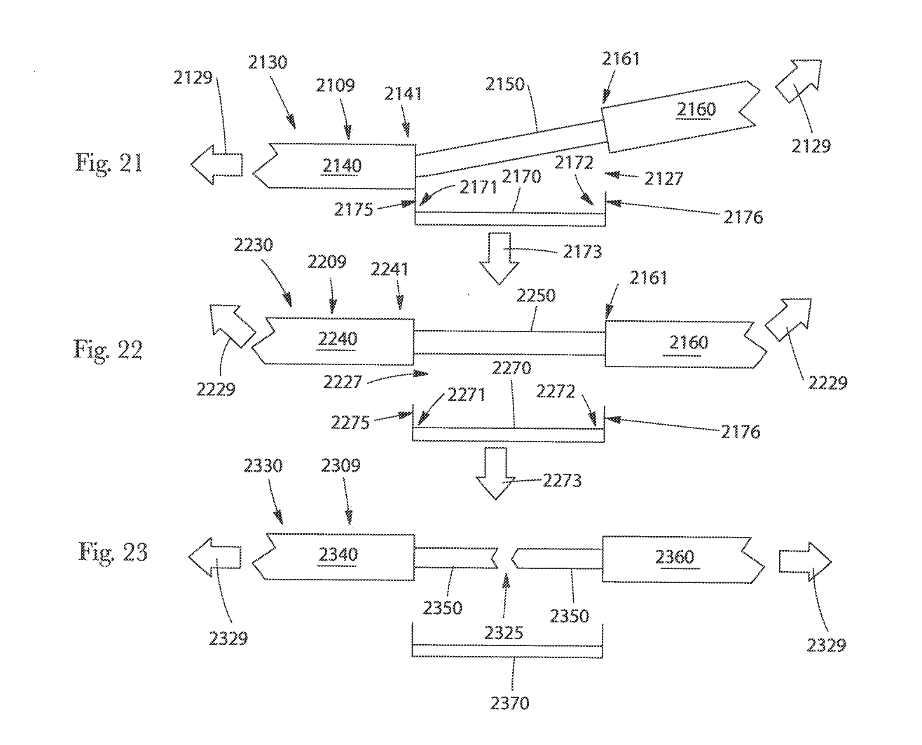

FIG. 21 illustrates an enlarged side view of a computer based model 2130 of a fiber 2109 that has been bonded at a bond site. Each of the elements of the embodiment of FIG. 21 is configured in the same way as the like-numbered element of the embodiment of FIG. 19, except as described below. The model 2130 is a representation of the model 1930 after being transformed by forces 2129 and 2173. The forces 2129 and 2173 caused stress and strain in the elements of the model 2130, resulting in failure of an element. Since the fiber 2109 had weakened portions, represented by the first and second fiber bond connections 2175, 2176, the second fiber bond connection 2176 failed, such that the second fiber segment 2160 broke off 2127 from the bond site 2170. As a result of the break off 2127, the first fiber segment 2140 is partially disconnected from the bond site 2170. This is a realistic representation of a first failure in the mode of fiber break off for the bonded fiber 2109. In the model 2130, the first fiber segment 2140 continues to be connected to the second fiber segment 2160 through the intermediate connection 2150.

FIG. 22 illustrates an enlarged side view of a computer based model 2230, which is the model 2130 at a subsequent point in time. Each of the elements of the embodiment of FIG. 22 is configured in the same way as the like-numbered element of the embodiment of FIG. 21, except as described below. The model 2230 is a representation of the model 2130 after being further transformed by forces 2229 and 2273. The forces 2229 and 2273 caused continued stress and strain in the elements of the model 2230, resulting in failure of an element. Since the fiber 2209 had weakened portions, represented by the first and second fiber bond connections 2275, 2276, the first fiber bond connection 2275 failed, such that the first fiber segment 2240 broke off 2227 from the bond site 2270. As a result of the break off 2227, the first fiber segment 2240 is fully disconnected from the bond site 2270. This is a realistic representation of a second failure in the mode of fiber break off for the bonded fiber 2209. In the model 2230, the first fiber segment 2240 continues to be connected to the second fiber segment 2260 through the intermediate connection 2250.

FIG. 23 illustrates an enlarged side view of a computer based model 2330, which is the model 2230 at a subsequent point in time. Each of the elements of the embodiment of FIG. 23 is configured in the same way as the like-numbered element of the embodiment of FIG. 22, except as described below. The model 2330 is a representation of the model 2130 after being further transformed by forces 2329. The forces 2329 caused continued stress and strain in the elements of the model 2330, resulting in failure of an element. Since the fiber 2309 had weakened portions, represented by the intermediate connection 2350, the intermediate connection 2350 failed, such that the fiber 2309 broke 2325. As a result of the fiber break 2325, the first fiber segment 2340 is disconnected from the second fiber segment 2360. This is a realistic representation of a failure in the mode of fiber break for the bonded fiber 2309.

The sequence of failure modes illustrated in the embodiments of FIGS. 19, 21, 22, and 23 is exemplary. In various embodiments, elements of the model 1930 of the embodiment of FIG. 19 may fail in a different order, may fail at the same time, or may not fail, depending on the relative strength of the elements and the boundary conditions applied to the model 1930, as will be understood by one of skill in the art.

The transformation of the model 1930 into the transformed models 2130, 2230, and 2330 can serve as a basis for transforming a computer based model of a bonded fibrous material, such as the fibrous material 1800 of the embodiment of FIG. 18. A computer based model can represent a transformed bonded fibrous material with a plurality of fibers wherein at least some, or substantially all, or even all of the overbonded fibers are represented as being transformed in the same way as the fibers 2109, 2209, and 2309 of the models 2130, 2230, and 2430, respectively. In such a model of an overbonded fibrous material, the transformation may not result in any fiber break, may result in some fiber breaks, may result in many fiber breaks, may result in a partial structural failure of the web as a whole, or may result in a complete structural failure of the web as a whole.

Program instructions can execute, causing a device to perform a method of transforming the model 1930 and representing the transformed models 2130, 2230, and 2330, including any of their alternative embodiments. Program instructions can also execute, causing a device to perform a method of transforming a computer based model of a fibrous material with fibers configured according to the model 1930, including any of its alternative embodiments, and representing the transformed model of the fibrous material, wherein the transformed fibers can be represented according to the models 2130, 2230, and 2330. The execution can be performed with software, hardware, and combinations thereof, as described herein. These program instructions and any of these representations or transformations can be stored on a computer-readable medium.

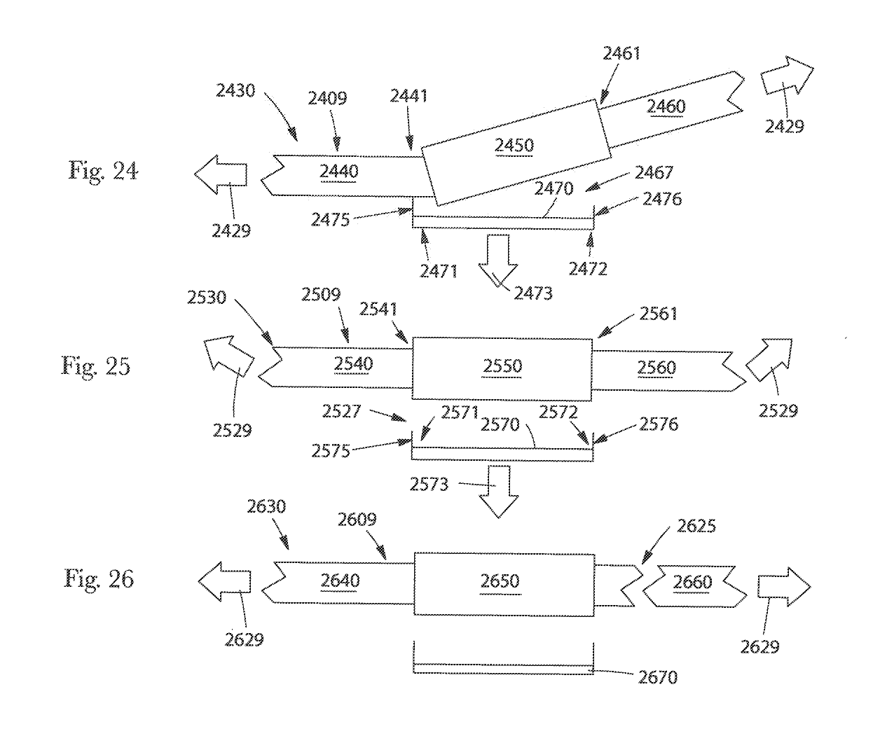

FIG. 24 illustrates an enlarged side view of a computer based model 2430 of a fiber 2409 that has been bonded at a bond site. Each of the elements of the embodiment of FIG. 24 is configured in the same way as the like-numbered element of the embodiment of FIG. 20, except as described below. The model 2430 is a representation of the model 2030 after being transformed by forces 2429 and 2473. The forces 2429 and 2473 caused stress and strain in the elements of the model 2430, resulting in failure of an element. Since the fiber 2409 had weakened portions, represented by the first and second fiber bond connections 2475, 2476, the second fiber bond connection 2476 failed, such that the second fiber segment 2460 broke off 2427 from the bond site 2470. As a result of the break off 2427, the first fiber segment 2440 is partially disconnected from the bond site 2470. This is a realistic representation of a first failure in the mode of fiber break off for the bonded fiber 2409. In the model 2430, the first fiber segment 2440 continues to be connected to the second fiber segment 2460 through the intermediate connection 2450.

FIG. 25 illustrates an enlarged side view of a computer based model 2530, which is the model 2430 at a subsequent point in time. Each of the elements of the embodiment of FIG. 25 is configured in the same way as the like-numbered element of the embodiment of FIG. 24, except as described below. The model 2530 is a representation of the model 2430 after being further transformed by forces 2529 and 2573. The forces 2529 and 2573 caused continued stress and strain in the elements of the model 2530, resulting in failure of an element. Since the fiber 2509 had weakened portions, represented by the first and second fiber bond connections 2575, 2576, the first fiber bond connection 2575 failed, such that the first fiber segment 2540 broke off 2527 from the bond site 2570. As a result of the break off 2527, the first fiber segment 2540 is fully disconnected from the bond site 2570. This is a realistic representation of a second failure in the mode of fiber break off for the bonded fiber 2509. In the model 2530, the first fiber segment 2540 continues to be connected to the second fiber segment 2560 through the intermediate connection 2550.

FIG. 26 illustrates an enlarged side view of a computer based model 2630, which is the model 2530 at a subsequent point in time. Each of the elements of the embodiment of FIG. 26 is configured in the same way as the like-numbered element of the embodiment of FIG. 25, except as described below. The model 2630 is a representation of the model 2530 after being further transformed by forces 2629. The forces 2629 caused continued stress and strain in the elements of the model 2630, resulting in failure of an element. Since the fiber 2609 had a strengthened portion, represented by the intermediate connection 2650, the fiber 2609 broke 2625 at a location outside of the intermediate connection 2650, in the second fiber segment 2660. As a result of the fiber break 2625, the second fiber segment 2660 is broken into two portions that are disconnected from each other. This is a realistic representation of a failure in the mode of fiber break for the bonded fiber 2609.

The sequence of failure modes illustrated in the embodiments of FIGS. 20, 24, 25, and 26 is exemplary. In various embodiments, elements of the model 2030 of the embodiment of FIG. 20 may fail in a different order, may fail at the same time, or may not fail, depending on the relative strength of the elements and the boundary conditions applied to the model 2030, as will be understood by one of skill in the art.

The transformation of the model 2030 into the transformed models 2430, 2530, and 2630 can serve as a basis for transforming a computer based model of a bonded fibrous material, such as the fibrous material 300 of the embodiment of FIG. 3. A computer based model can represent a transformed bonded fibrous material with a plurality of fibers wherein at least some, or substantially all, or even all of the overbonded fibers are represented as being transformed in the same way as the fibers 2409, 2509, and 2609 of the models 2430, 2530, and 2630, respectively. In such a model of an overbonded fibrous material, the transformation may not result in any fiber break, may result in some fiber breaks, may result in many fiber breaks, may result in a partial structural failure of the web as a whole, or may result in a complete structural failure of the web as a whole.

Program instructions can execute, causing a device to perform a method of transforming the model 2030 and representing the transformed models 2430, 2530, and 2630, including any of their alternative embodiments. Program instructions can also execute, causing a device to perform a method of transforming a computer based model of a fibrous material with fibers configured according to the model 2030, including any of its alternative embodiments, and representing the transformed model of the fibrous material, wherein the transformed fibers can be represented according to the models 2430, 2530, and 2630. The execution can be performed with software, hardware, and combinations thereof, as described herein. These program instructions and any of these representations or transformations can be stored on a computer-readable medium.

The present disclosure provides methods for modeling a processed fibrous material. The methods can model the physical behavior of a processed fiber, while accounting for the weakening, strengthening, and changes from a process. In particular, the methods can model the failure modes of a processed fiber. The methods can be used to create a realistic model of a processed fibrous material. As a result, processed fibrous materials can be evaluated and modified as computer based models before they are tested as real world things. Such models can also be used to analyze existing real world things, and/or to compare existing real world things with variations and with new things.

In particular, computer based models of processed fibrous materials, as described in the present disclosure, can be used in simulated testing, to determine their performance characteristics. For example, in one kind of simulated testing, various boundary conditions can be applied to a computer based model of a bonded fibrous web, to determine the performance of the web. The model of the web can be pulled in tension, while measuring the applied forces and/or displacements as well as the stresses, strains, and deformations experienced by the web, over a period of time. These measurements can then be used to calculate various mechanical properties of the modeled web, such as its stiffness, elasticity, tensile strength, strain energy, neckdown, etc. In some embodiments, a computer based model of a fibrous material can be used in simulated testing to evaluate various geometries of the material, such as its thickness, density, porosity, etc.

A computer based model of a processed fibrous material can be easily varied, to determine how such variations affect the mechanical properties of the web. As an example, various bond patterns with differing geometries and degrees of bonding can be applied to a model of a fibrous web, to determine how the bond patterns affect the performance of the bonded web. In some embodiments, a computer based model of a processed fibrous material can be systematically varied in a virtual design of experiments that tests many variations of several aspects of the model. The empirical results of the virtual experiments can be statistically analyzed to determine the relationship between the variations and the mechanical properties of the web.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests, or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A method comprising:
representing a bonded fiber with a computer based model of the bonded fiber, including a first fiber segment, a second fiber segment, and an intermediate connection, wherein the intermediate connection connects the first fiber segment to the second fiber segment, the first fiber segment has a first fiber breaking strength, and the intermediate connection has an intermediate connection breaking strength that differs from the first fiber breaking strength;
transforming the computer based model of the bonded fiber, by modeling a physical behavior of the bonded fiber to form a transformed bonded fiber; and
representing the transformed bonded fiber with a computer based model of the transformed bonded fiber.

2. The method of claim 1, wherein the representing of the bonded fiber includes representing the bonded fiber with a computer based model of the bonded fiber, wherein the intermediate connection breaking strength is greater than the first fiber breaking strength.

3. The method of claim 1, wherein the representing of the bonded fiber includes representing the bonded fiber with a computer based model of the bonded fiber, wherein the intermediate connection breaking strength is less than the first fiber breaking strength.

4. The method of claim 1, wherein the representing of the bonded fiber includes representing the bonded fiber with a computer based model of the bonded fiber, wherein the first fiber segment has a first tensile breaking strength and the intermediate connection has an intermediate connection tensile breaking strength that is less than the first tensile breaking strength.

5. The method of claim 1, wherein the representing of the bonded fiber includes representing the bonded fiber with a computer based model of the bonded fiber, wherein the first fiber segment has a first tensile breaking strength and the intermediate connection has an intermediate connection tensile breaking strength that is based on the first fiber breaking strength and a predetermined fiber strength factor.

6. The method of claim 1, wherein the representing of the bonded fiber includes representing the bonded fiber with a computer based model of the bonded fiber, wherein the first fiber segment has a first tensile breaking strength and a first strain energy at the first fiber breaking strength, and the intermediate connection has an intermediate connection breaking strength that is based on the first strain energy and a predetermined fiber strength factor.

7. The method of claim 1, wherein the representing of the bonded fiber includes representing the bonded fiber with a computer based model of the bonded fiber, wherein the first fiber segment has a first tensile breaking strength and a first strain energy at the first fiber breaking strength, the intermediate connection has an intermediate connection breaking strength and an intermediate connection strain energy at the intermediate breaking strength, and the intermediate connection strain energy is equal to the first strain energy multiplied by the predetermined fiber strength factor.

8. The method of claim 1, wherein the representing of the bonded fiber includes representing the bonded fiber with a computer based model of the bonded fiber, wherein the first fiber segment has a first tensile breaking strength and a first strain energy at the first fiber breaking strength, the intermediate connection has an intermediate connection breaking strength and an intermediate connection strain energy at the intermediate breaking strength, and the intermediate connection strain energy is less than or about equal to 90% of the first strain energy.

9. The method of claim 1, wherein the representing of the bonded fiber includes representing the bonded fiber with a computer based model of the bonded fiber, wherein the first fiber segment has a first tensile breaking strength and a first strain energy at the first fiber breaking strength, the intermediate connection has an intermediate connection breaking strength and an intermediate connection strain energy at the intermediate breaking strength, and the intermediate connection strain energy is less than or about equal to 80% of the first strain energy.

10. The method of claim 1, wherein the representing of the bonded fiber includes representing the bonded fiber with a computer based model of the bonded fiber, wherein the first fiber segment has a first tensile breaking strength and a first strain energy at the first fiber breaking strength, the intermediate connection has an intermediate connection breaking strength and an intermediate connection strain energy at the intermediate breaking strength, and the intermediate connection strain energy is less than or about equal to 70% of the first strain energy.

11. The method of claim 1, wherein the representing of the bonded fiber includes representing the bonded fiber with a computer based model of the bonded fiber, wherein the intermediate connection directly connects the first fiber segment to the second fiber segment.

12. The method of claim 1, wherein the representing includes representing the bonded fiber with a computer based model of the bonded fiber, including representing the first fiber segment with one or more elements selected from the group including:
beam elements;
truss elements; and
combinations thereof.

13. The method of claim 1, wherein the representing includes representing the bonded fiber with a computer based model of the bonded fiber, including representing the intermediate connection with one or more elements selected from the group including:
beam elements;
truss elements; and
combinations thereof.

14. The method of claim 1, wherein:
the representing includes representing the bonded fiber with a computer based model of the bonded fiber, wherein the intermediate connection connects a location on the first fiber segment to a location on the second fiber segment;
the transforming includes transforming the computer based model of the bonded fiber by applying a first force to the first fiber segment and a second force to the second fiber segment, breaking the intermediate connection; and
the representing includes representing the transformed bonded fiber with a computer based model of the transformed bonded fiber, wherein the location on the first fiber segment is disconnected from the location on the second fiber segment.

15. The method of claim 1, wherein the representing includes representing the bonded fiber with a computer based model of the bonded fiber, wherein the location on the first fiber segment is an end of the first fiber segment and the location on the second fiber segment is an end of the second fiber segment.

16. The method of claim 1, wherein the representing of the bonded fiber includes representing the bonded fiber with a computer based model of the bonded fiber, including a bond site with a defined geometry, wherein the intermediate connection has an overall length based on the geometry of the bond site.

17. The method of claim 1, wherein the representing of the bonded fiber includes representing the bonded fiber with a computer based model of the bonded fiber, including a bond site, wherein the intermediate connection extends across at least a portion of the bond site.

18. The method of claim 1, wherein the representing of the bonded fiber includes representing the bonded fiber with a computer based model of the bonded fiber, including a bond site, wherein the bonded fiber is connected to the bond site.

19. The method of claim 1, wherein:
the bonded fiber is a first bonded fiber; and
the representing of the bonded fiber includes representing the bonded fiber with a computer based model of the bonded fiber, including a bond site and a second bonded fiber, wherein the first fiber is connected to the bond site and the second fiber is connected to the bond site.

20. The method of claim 1, including representing a bonded fibrous material with a computer based model of the bonded fibrous web, wherein the bonded fibrous material includes a plurality of fibers configured as the bonded fiber.

21. A method comprising:
representing a bonded fibrous material with a computer based model of the bonded fibrous material, including a plurality of fibers and a plurality of bond sites, wherein each of the fibers includes a first fiber segment, a second fiber segment, and an intermediate connection, wherein the intermediate connection connects the first fiber segment to the second fiber segment, the first fiber segment has a first fiber breaking strength, the intermediate connection is has an intermediate connection breaking strength that differs from the first fiber breaking strength, and each of the fibers is connected to at least one of the bond sites;
transforming the computer based model of the bonded fibrous material, by modeling a physical behavior of the bonded fibrous material to form a transformed bonded fibrous material; and
representing the transformed bonded fibrous material with a computer based model of the transformed bonded fibrous material.

22. A computer readable medium having instructions for causing a device to perform a method, the method comprising:
representing a bonded fiber with a computer based model of the bonded fiber, including a first fiber segment, a second fiber segment, and an intermediate connection, wherein the intermediate connection connects the first fiber segment to the second fiber segment, the first fiber segment has a first fiber breaking strength, and the intermediate connection has an intermediate connection breaking strength that differs from the first fiber breaking strength;
transforming the computer based model of the bonded fiber, by modeling a physical behavior of the bonded fiber to form a transformed bonded fiber; and
representing the transformed bonded fiber with a computer based model of the transformed bonded fiber.

23. A method comprising:
representing a bonded fiber with a computer based model of the bonded fiber, including a bond site, a fiber segment, and a fiber bond connection, wherein the fiber bond connection connects the fiber segment to the bond site, the fiber segment has a fiber segment breaking strength and the fiber bond connection has a fiber bond connection breaking strength that is less than the fiber segment breaking strength;
transforming the computer based model of the bonded fiber, by modeling a physical behavior of the bonded fiber to form transformed bonded fiber; and
representing the transformed bonded fiber with a computer based model of the transformed bonded fiber.

24. The method of claim 23, wherein the representing of the bonded fiber includes representing the bonded fiber with a computer based model of the bonded fiber, wherein the fiber segment has a fiber segment tensile breaking strength and the fiber bond connection has a fiber bond connection tensile breaking strength that is less than the fiber segment tensile breaking strength.

25. The method of claim 23, wherein the representing of the bonded fiber includes representing the bonded fiber with a computer based model of the bonded fiber, wherein the fiber bond connection breaking strength is based on the fiber segment breaking strength and a predetermined connection strength factor.

26. The method of claim 23, wherein the representing of the bonded fiber includes representing the bonded fiber with a computer based model of the bonded fiber, wherein the fiber segment has a fiber segment strain energy at the fiber segment breaking strength and the fiber bond connection breaking strength is based on the fiber strain energy and a predetermined connection strength factor.

27. The method of claim 23, wherein the representing of the bonded fiber includes representing the bonded fiber with a computer based model of the bonded fiber, wherein the fiber segment has a fiber segment strain energy at the fiber breaking strength, the fiber bond connection has a fiber bond connection strain energy at the fiber bond connection breaking strength, and the fiber bond connection strain energy is equal to the fiber segment strain energy multiplied by a predetermined connection strength factor.

28. The method of claim 23, wherein the representing of the bonded fiber includes representing the bonded fiber with a computer based model of the bonded fiber, wherein the fiber has a fiber strain energy at the fiber breaking strength, a fiber bond connection strain energy is equal to the fiber strain energy multiplied by the predetermined connection strength factor, the fiber bond connection strain energy correlates with a fiber bond connection breaking stress that is based on a stress-strain curve for the fiber, the fiber bond connection breaking stress correlates with a fiber bond connection breaking force that is based on a cross-sectional area of the fiber, and the fiber bond connection is configured to fail at the fiber bond connection breaking force.

29. The method of claim 23, wherein the representing of the bonded fiber includes representing the bonded fiber with a computer based model of the bonded fiber, wherein the fiber segment has a fiber segment strain energy at the fiber segment breaking strength, the fiber bond connection has a fiber bond connection strain energy at the fiber bond connection breaking strength, and the fiber bond connection strain energy is less than or about equal to 60% of the fiber segment strain energy.

30. The method of claim 23, wherein the representing of the bonded fiber includes representing the bonded fiber with a computer based model of the bonded fiber, wherein the fiber segment has a fiber segment strain energy at the fiber segment breaking strength, the fiber bond connection has a fiber bond connection strain energy at the fiber bond connection breaking strength, and the fiber bond connection strain energy is less than or about equal to 50% of the fiber segment strain energy.

31. The method of claim 23, wherein the representing of the bonded fiber includes representing the bonded fiber with a computer based model of the bonded fiber, wherein the fiber segment has a fiber segment strain energy at the fiber segment breaking strength, the fiber bond connection has a fiber bond connection strain energy at the fiber bond connection breaking strength, and the fiber bond connection strain energy is less than or about equal to 40% of the fiber segment strain energy.

32. The method of claim 23, wherein the representing of the bonded fiber includes representing the bonded fiber with a computer based model of the bonded fiber, wherein the fiber bond connection directly connects the fiber segment to the bond site.

33. The method of claim 23, wherein the representing of the bonded fiber includes representing the bonded fiber with a computer based model of the bonded fiber, wherein the fiber bond connection is one or more connector elements.

34. The method of claim 23, wherein the representing of the bonded fiber includes representing the bonded fiber with a computer based model of the bonded fiber, wherein the fiber bond connection is a contact condition.

35. The method of claim 23, wherein the representing includes representing the bonded fiber with a computer based model of the bonded fiber, including representing the fiber segment with one or more beam elements.

36. The method of claim 23, wherein the representing of the bonded fiber includes representing the bonded fiber with a computer based model of the bonded fiber, wherein the bond site has a bond site perimeter and the fiber bond connection is disposed proximate to a location on the bond site perimeter.

37. The method of claim 23, wherein:
the representing includes representing the bonded fiber with a computer based model of the bonded fiber, wherein the fiber bond connection connects a location on the bond site to a location along the fiber segment;
the transforming includes transforming the computer based model of the bonded fiber by applying a first force to the fiber segment and a second force to the bond site, breaking the fiber bond connection; and
the representing includes representing the transformed bonded fiber with a computer based model of the transformed bonded fiber, wherein the location on the bond site is disconnected from the location along the fiber segment.

38. The method of claim 23, wherein:
the fiber bond connection is a first fiber bond connection with a first fiber bond connection breaking strength; and
the representing of the bonded fiber includes representing the bonded fiber with a computer based model of the bonded fiber, including a second bond connection, wherein the second fiber bond connection connects the fiber segment to the bond site.

39. The method of claim 23, wherein:
the fiber bond connection is a first fiber bond connection with a first fiber bond connection breaking strength; and
the representing of the bonded fiber includes representing the bonded fiber with a computer based model of the bonded fiber, including a second bond connection, wherein the second fiber bond connection connects the fiber segment to the bond site, and the second fiber bond connection has a second fiber bond connection breaking strength that is less than the fiber segment breaking strength.

40. The method of claim 23, wherein:
the fiber bond connection is a first fiber bond connection with a first fiber bond connection breaking strength; and
the representing of the bonded fiber includes representing the bonded fiber with a computer based model of the bonded fiber, including a second bond connection, wherein the second fiber bond connection connects the fiber segment to the bond site, and the second fiber bond connection has a second fiber bond connection breaking strength that is about equal to the first fiber bond connection breaking strength.

41. The method of claim 23, wherein:
the fiber bond connection is a first fiber bond connection; and
the representing of the bonded fiber includes representing the bonded fiber with a computer based model of the bonded fiber, including a second fiber bond connection, wherein the bond site has a bond site perimeter, the fiber segment extends across the bond site, the first fiber bond connection connects a first location on the bond site perimeter to a first location along the fiber segment, and the second fiber bond connection connects a second location on the bond site perimeter to a second location along the fiber segment.

42. The method of claim 23, wherein the representing of the bonded fiber includes representing the bonded fiber with a computer based model of the bonded fiber, wherein the bond site is a rigid bond site.

43. The method of claim 23, wherein the representing includes representing the bonded fiber with a computer based model of the bonded fiber, including a first fiber segment, a second fiber segment, and an intermediate connection, wherein the intermediate connection connects the first fiber segment to the second fiber segment, the first fiber segment has a first fiber segment breaking strength, and the intermediate connection has an intermediate connection breaking strength that is less than the first fiber segment breaking strength, wherein the fiber bond connection connects a location on the bond site to a location along the first fiber segment.

44. The method of claim 23, wherein:
the representing includes representing the bonded fiber with a computer based model of the bonded fiber, including a first fiber segment, a second fiber segment, and an intermediate connection, wherein the intermediate connection connects a location on the first fiber segment to a location on the second fiber segment, the first fiber segment has a first fiber segment breaking strength, and the intermediate connection has an intermediate connection breaking strength that is less than the first fiber segment breaking strength, wherein the fiber bond connection connects a location on the bond site to a location along the first fiber segment;
the transforming includes transforming the computer based model of the bonded fiber by applying a first force to the fiber and a second force to the bond site, breaking the fiber bond connection while the intermediate connection continues to connect the first fiber segment to the second fiber segment; and
the representing includes representing the transformed bonded fiber with a computer based model of the transformed bonded fiber, wherein the location on the bond site is disconnected from the location along the fiber.

45. The method of claim 44, wherein:
after the breaking of the fiber bond connection, the transforming includes transforming the computer based model of the bonded fiber by applying a third force to the first fiber segment and a fourth force to the second fiber segment, breaking the intermediate connection; and
the representing includes representing the transformed bonded fiber with a computer based model of the transformed bonded fiber, wherein the location on the first fiber segment is disconnected from the location on the second fiber segment.

46. The method of claim 23, including representing a bonded fibrous material with a computer based model of the bonded fibrous web, wherein the bonded fibrous material includes a plurality of fibers configured as the bonded fiber.

47. A method comprising:
representing a bonded fibrous material with a computer based model of the bonded fibrous material, including a plurality of fibers, wherein each of the fibers includes a bond site, a fiber segment, and a fiber bond connection, wherein the fiber bond connection connects the fiber segment to the bond site, the fiber segment has a fiber segment breaking strength and the fiber bond connection has a fiber bond connection breaking strength that is less than the fiber segment breaking strength;
transforming the computer based model of the bonded fiber, by modeling a physical behavior of the bonded fiber to form transformed bonded fiber; and
representing the transformed bonded fiber with a computer based model of the transformed bonded fiber.

48. A computer readable medium having instructions for causing a device to perform a method, the method comprising:
representing a bonded fiber with a computer based model of the bonded fiber, including a bond site, a fiber segment, and a fiber bond connection, wherein the fiber bond connection connects the fiber segment to the bond site, the fiber segment has a fiber segment breaking strength and the fiber bond connection has a fiber bond connection breaking strength that is less than the fiber segment breaking strength;
transforming the computer based model of the bonded fiber, by modeling a physical behavior of the bonded fiber to form transformed bonded fiber; and
representing the transformed bonded fiber with a computer based model of the transformed bonded fiber.
